(19) United States
(12) Patent Application Publication
(10) Pub. No.: US 2011/0244390 A1
(43) Pub. Date: Oct. 6, 2011

(54) DONOR ELEMENT WITH MALEIC ANHYDRIDE BASED POLYMERS FOR THERMAL TRANSFER

(76) Inventors: Thomas C. Felder, Kennett Square, PA (US); Christopher Ferguson, Hartlepool (GB); Richard Paul Pankratz, Circleville, OH (US); Julian Neal Robinson, North Yorkshire (GB); Debra S. Strickland, Richmond, VA (US)

(21) Appl. No.: 12/279,591

(22) PCT Filed: Apr. 19, 2007
(86) PCT No.: PCT/US07/09575

§ 371 Date: Apr. 13, 2011

Related U.S. Application Data
(60) Provisional application No. 60/793,523, filed on Apr. 20, 2006.

(51) Int. Cl. G03C 8/00; B05D 5/06; B05D 1/36

(52) U.S. Cl. 430/200; 427/162

(57) ABSTRACT

This invention pertains to a donor element for use with a receiver element in an imagable assemblage for light-induced transfer of material from the donor element to the receiver element. Specifically, this invention relates to such a donor element comprising a copolymer based on styrene and maleic anhydride.

### FIELD OF THE INVENTION

This invention pertains to a donor element for use with a receiver element in an imagable assemblage for light-induced transfer of material from the donor element to the receiver element. Specifically, this invention relates to such a donor element comprising maleic anhydride-based polymers.

### BACKGROUND

Donor elements for use with a receiver element, in an imagable assemblage for light-induced transfer of material from the donor element to the receiver element, typically include multiple layers. The layers can include, but are not limited to, a support layer, a light-to-heat conversion (LTHC) layer, and a transfer layer. Typically, a support layer such as a 50 μm polyethylene terephthalate film is sequentially coated with a light-to-heat conversion layer precursor. The precursor is then converted to a final light-to-heat conversion layer by drying, and subsequently a transfer layer precursor is coated above the light-to-heat conversion layer, opposite the support layer, and converted to a transfer layer by drying.

Materials can be selectively thermally-transferred to form elements that are useful in electronic displays and other devices and objects. Specifically, selective thermal transfer of color filters, spacers, polarizers, conductive layers, transistors, phosphors and organic electroluminescent materials have all been proposed. Materials such as colorants can be selectively thermally-transferred to form objects such as a proof copy of a reference image.

There remains a need for improvements in donor elements for thermal transfer imaging, in the effectiveness and selectivity of moving transferable material from a donor element, and in the effectiveness and selectivity of depositing and adhering transferable material, and fixing transferred material to a receiver element. Improvements in thermal transfer imaging donor elements that decrease unintended transfer of layers to a receiver element are sought. Improvements in thermal transfer imaging donor elements that improve the handling characteristics and damage resistance of the donor element are sought.

There remains a need for improvements to thermal transfer donor elements and improvements in their use with receiver elements in an imagable assemblage, in order to improve at least one of thermal transfer efficiency, independence of thermal transfer efficiency from any variation of heating, independence of thermal transfer efficiency from any variation of environmental conditions such as humidity and temperature, completeness of mass transfer, freedom from unintended mass transfer, clean separation of mass-transferred and unimaged regions of the donor element, and smoothness of the surface and edges of mass-transferred material.

U.S. Pat. No. 5,922,512 (DoMinh) discloses preparing an imaging member, such as a negative-working printing plate, using a heat sensitive imaging layer comprised of a heat-sensitive vinyl polymer and optionally, a photo-thermal conversion material. The heat-sensitive polymer has recurring units containing a cyclic anhydride that decarboxylates upon application of thermal energy (such as from infra red irradiation), rendering the polymer more hydrophobic in such infra red-exposed areas. Upon contact with a neutral or acidic pH solution, the polymer is then rendered more hydrophilic in unexposed areas.

On the other hand, the present invention relates to actual transfer of material from the transfer layer of the donor element onto the receiver element rather than selectively making the infra red-exposed areas more hydrophobic. Also, the present invention uses a dry process unlike the '512 patent which uses a solvent to create the image on the negative plate. The '512 patent discloses a completely different technology, in that, it is based on the immiscibility of oil and water. Oily material or ink is retained by hydrophobic areas. Hydrophobic areas are created by exposure of an imaging layer to infra-red radiation.

Further, by incorporating a cyclic anhydride-type polymer in the light-to-heat conversion layer of the donor element, the present invention discloses a donor element that offers higher sensitivity and control for transferring material from the transfer layer to the receiver element and that too at a lower expenditure of energy. It is speculated that upon irradiation, the anhydride loop is closed releasing a small molecule that acts as a transfer vehicle, transferring the material to be transferred from the donor element to the receiving element.

Finally, the present invention also discloses making such donor elements and using such donor elements, for example, in display technology.

### SUMMARY OF. THE INVENTION

This invention relates to a donor element for light-induced transfer, comprising:
(a) a support layer;
(b) a light-to-heat conversion layer disposed adjacent one side of said support layer, wherein said light-to-heat conversion layer comprises a light absorber; and
(c) a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer.
This invention further relates to a donor element as recited above, wherein said maleic anhydride-based polymer comprises a polymer selected from the group consisting of:
   (i) maleic anhydride homopolymer;
   (ii) maleic acid homopolymer;
   (iii) fumaric acid homopolymer;
   (iv) homopolymer of monoester of maleic acid;
   (v) homopolymer of monoester of fumaric acid;
   (vi) maleic anhydride copolymers;
   (vii) maleic acid copolymers;
   (viii) fumaric acid copolymers;
   (ix) copolymers of monoester of maleic acid;
   (x) copolymers of monoester of fumaric acid;
   (xi) chemical combinations thereof;
   (xii) physical mixtures thereof; and
   (xiii) combinations thereof.;
      wherein said maleic anhydride repeat unit is selected from at least one of the three configurations represented in

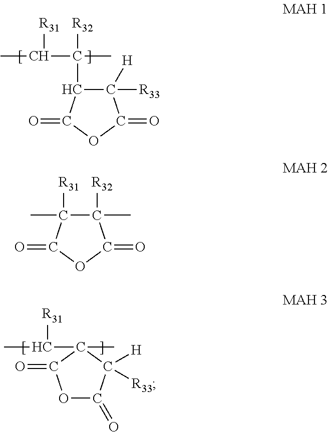

wherein said maleic acid repeat unit is selected from at least one of the three configurations represented in

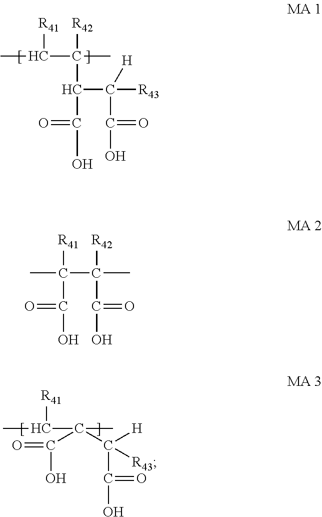

wherein said fumaric acid repeat unit is selected from at least one of the three configurations represented in

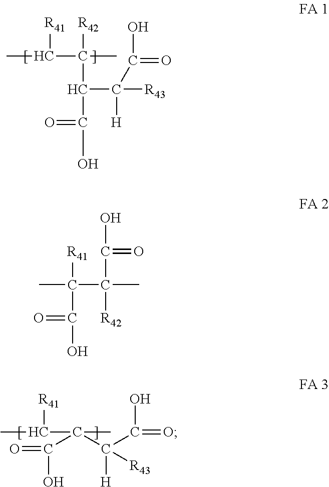

wherein said repeat unit of monoester of maleic acid is selected from at least one of the three configurations represented in

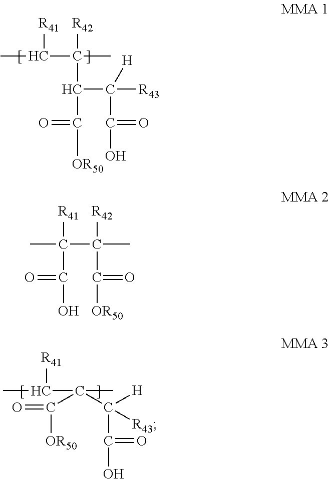

and wherein said repeat unit of monoester of fumaric acid is selected from at least one of the three configurations represented in

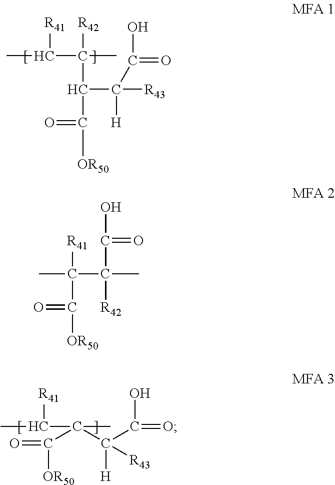

wherein, R₃₁, R₃₂, R₃₃, R₄₁, R₄₂, R₄₃ are the same or different groups, which can be hydrogen or alkyl of one to about five carbon atoms;
and
R₅₀ is functional group selected from:
   (a) alkyl, aralkyl, alkyl-substituted aralkyl radicals containing from one to about twenty carbon atoms;
   (b) oxyalkylated derivatives of alkyl, aralkyl, alkyl-substituted aralkyl radicals containing from about two to about four carbon atoms in each oxyalkylene group, which can be of one to about twenty repeating units;
   (c) oxyalkylated derivatives of alkyl, aralkyl, alkyl-substituted aralkyl radicals containing from about two to about four carbon atoms in each oxyalkylene group, which can be of one to about six repeating units;
   (d) at least one unsaturated moiety;
   (e) at least one heteroatom moiety;
   (f) alkaline molecules capable of forming salts selected from Li, Na, K and NH₄⁺; and
   (g) combinations thereof.

This invention also relates to a method of making a donor element, comprising:
(a) providing a support layer;
(b) providing a light-to-heat conversion layer disposed adjacent one side of said support layer, wherein said light-to-heat conversion layer comprises a light absorber; and
(c) providing a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer.

This invention further relates to a method as recited above, wherein said maleic anhydride-based polymer comprises a polymer selected from the group consisting of:
(i) maleic anhydride homopolymer;
(ii) maleic acid homopolymer;
(iii) fumaric acid homopolymer;
(iv) homopolymer of monoester of maleic acid;
(v) homopolymer of monoester of fumaric acid;
(vi) maleic anhydride copolymers;
(vii) maleic acid copolymers;
(viii) fumaric acid copolymers;
(ix) copolymers of monoester of maleic acid;
(x) copolymers of monoester of fumaric acid;
(xi) chemical combinations thereof;
(xii) physical mixtures thereof; and
(xiii) combinations thereof;
   wherein said maleic anhydride repeat unit is selected from at least one of the three configurations represented in

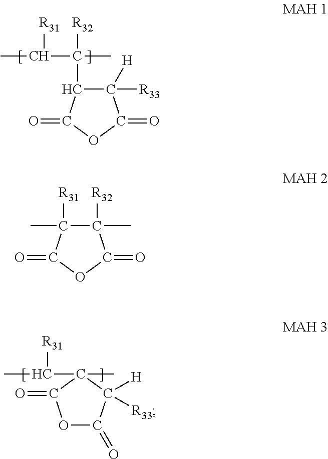

wherein said maleic acid repeat unit is selected from at least one of the three configurations represented in

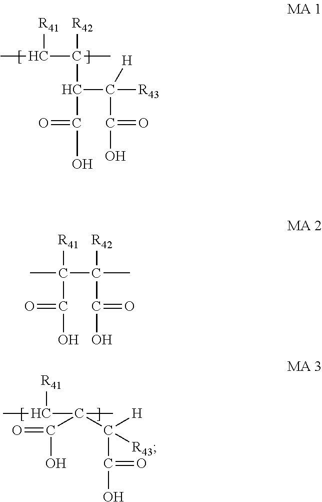

wherein said fumaric acid repeat unit is selected from at least one of the three configurations represented in

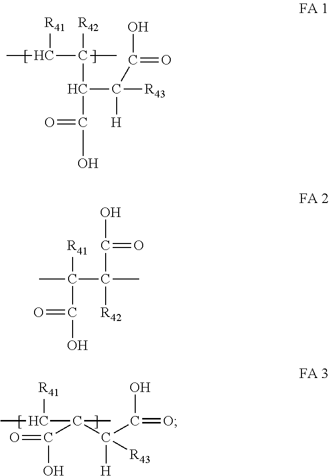

wherein said repeat unit of monoester of maleic acid is selected from at least one of the three configurations represented in

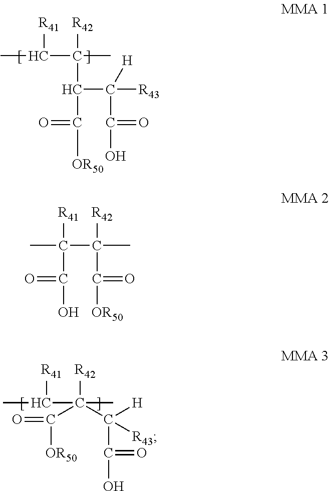

and wherein said repeat unit of monoester of fumaric acid is selected from at least one of the three configurations represented in

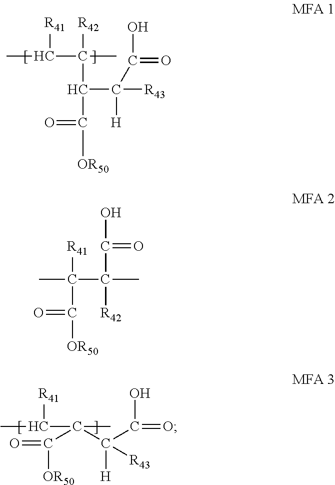

wherein, R₃₁, R₃₂, R₃₃, R₄₁, R₄₂, R₄₃ are the same or different groups, which can be hydrogen or alkyl of one to about five carbon atoms;
and
R₅₀ is functional group selected from:
   (a) alkyl, aralkyl, alkyl-substituted aralkyl radicals containing from one to about twenty carbon atoms;
   (b) oxyalkylated derivatives of alkyl, aralkyl, alkyl-substituted aralkyl radicals containing from about two to about four carbon atoms in each oxyalkylene group, which can be of one to about twenty repeating units;
   (c) oxyalkylated derivatives of alkyl, aralkyl, alkyl-substituted aralkyl radicals containing from about two to about four carbon atoms in each oxyalkylene group, which can be of one to about six repeating units;
   (d) at least one unsaturated moiety;
   (e) at least one heteroatom moiety;
   (f) alkaline molecules capable of forming salts selected from Li, Na, K and NH₄⁺; and
   (g) combinations thereof.
This invention also relates to a method of using a donor element in a thermal transfer process to form an image, comprising:
(I) providing an assemblage of a donor element and a receiver element, said donor element comprising:
   (a) a support layer;
   (b) a light-to-heat conversion layer disposed adjacent one side of said support layer, wherein said light-to-heat conversion layer comprises a light absorber;
   and
   (c) a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer;
(II) image-wise exposing said assemblage to light whereby at least a portion of said image-wise exposed transfer layer is transferred to said receiver element to form an image; and
(III) separating said donor element from said receiver element, thereby revealing said image on said receiver element.
This invention further relates to a method as recited above, wherein said maleic anhydride-based polymer comprises a polymer selected from the group consisting of:
   (i) maleic anhydride homopolymer;
   (ii) maleic acid homopolymer;
   (iii) fumaric acid homopolymer;
   (iv) homopolymer of monoester of maleic acid;
   (v) homopolymer of monoester of fumaric acid;
   (vi) maleic anhydride copolymers;
   (vii) maleic acid copolymers;
   (viii) fumaric acid copolymers;
   (ix) copolymers of monoester of maleic acid;
   (x) copolymers of monoester of fumaric acid;
   (xi) chemical combinations thereof;
   (xii) physical mixtures thereof; and
   (xiii) combinations thereof.;
      wherein said maleic anhydride repeat unit is selected from at least one of the three configurations represented in

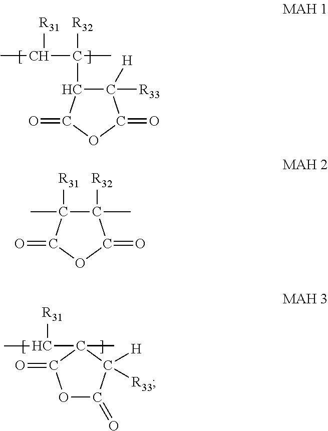

wherein said maleic acid repeat unit is selected from at least one of the three configurations represented in

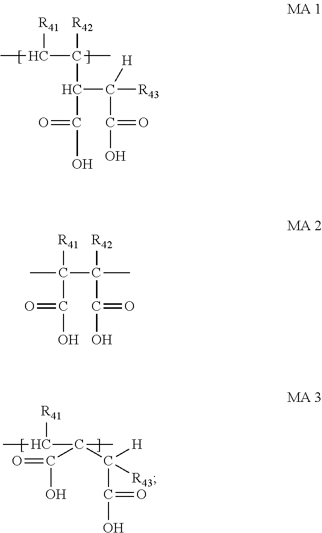

wherein said fumaric acid repeat unit is selected from at least one of the three configurations represented in

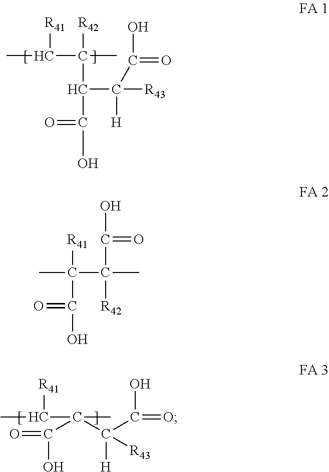

wherein said repeat unit of monoester of maleic acid is selected from at least one of the three configurations represented in

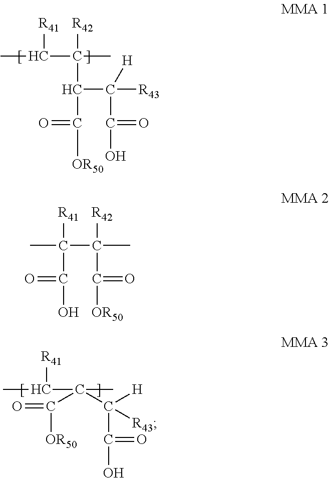

and wherein said repeat unit of monoester of fumaric acid is selected from at least one of the three configurations represented in

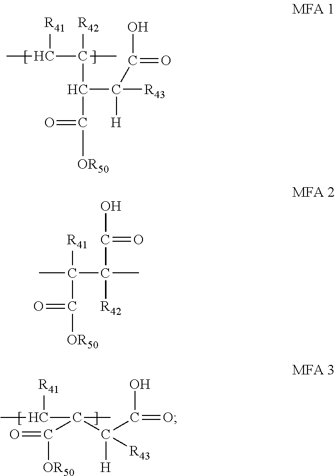

wherein, R₃₁, R₃₂, R₃₃, R₄₁, R₄₂, R₄₃ are the same or different groups, which can be hydrogen or alkyl of one to about five carbon atoms;
and
R₅₀ is functional group selected from:
   (a) alkyl, aralkyl, alkyl-substituted aralkyl radicals containing from one to about twenty carbon atoms;
   (b) oxyalkylated derivatives of alkyl, aralkyl, alkyl-substituted aralkyl radicals containing from about two to about four carbon atoms in each oxyalkylene group, which can be of one to about, twenty repeating units;
   (c) oxyalkylated derivatives of alkyl, aralkyl, alkyl-substituted aralkyl radicals containing from about two to about four carbon atoms in each oxyalkylene group, which can be of one to about six repeating units;
   (d) at least one unsaturated moiety;
   (e) at least one heteroatom moiety;
   (f) alkaline molecules capable of forming salts selected from Li, Na, K and NH₄⁺; and
   (g) combinations thereof.

### BRIEF DESCRIPTION OF THE DRAWINGS

FIG. 1 is a schematic cross-section of one embodiment of a donor element comprising a light-to-heat conversion layer containing a polymer based on styrene and maleic anhydride.

FIG. 2 corresponds to the three configurations based on maleic anhydride repeat unit.

FIG. 3 corresponds to the three configurations based on maleic anhydride acid repeat unit.

FIG. 4 corresponds to the three configurations based on fumaric acid repeat unit.

FIG. 5 corresponds to the three configurations based on monoester of maleic acid repeat unit.

FIG. 6 corresponds to the three configurations based on monoester of fumaric acid repeat unit.

FIG. 7 shows exemplary reactions that a styrene maleic anhydride-based polymer may undergo, such as substitution, imidization, and neutralization.

FIG. 8 is a schematic cross-section of different embodiments of an imagable assemblage of a donor element adjacent a receiver element, where the imagable assemblage is imaged by light.

FIG. 9 shows an embodiment of an imagable assemblage with the transfer layer of the donor element in intermittent contact with the receiver element along the surface of previously transferred material placed upon receiver base layer.

FIG. 10 is a schematic cross-section of an imaged donor element and an imaged receiver element of an imaged and separated imagable assemblage.

### DETAILED DESCRIPTION OF THE INVENTION

In one embodiment, the present invention comprises an imagable assemblage, i.e., the combination of the donor element and the receiver element. The donor element of the present invention comprises a support layer having a first side and a second side, a light-to-heat conversion layer having a first side and a second side, and a transfer layer having a first side and a second side.

The first side of said light-to-heat conversion layer is disposed adjacent said second side of said support. The first side of said transfer layer is disposed adjacent said second side of said light-to-heat conversion layer. In the assemblage of the present invention, the receiver element is located adjacent to the transfer layer, on the side opposite the support layer.

By “layer is disposed adjacent” is meant that said layer is in closer proximity to a particular side of another layer to which it is deemed adjacent, rather than the other side of said another layer to which said layer is deemed adjacent.

According to the present invention, “adjacent” does not suggest that the two layers are necessarily in physical contact.

The light-to-heat conversion layer comprises a light absorber. The light-to-heat conversion layer also comprises copolymer based on styrene and maleic anhydride.

The transfer layer comprises a material capable of being image-wise transferred from said donor element to an adjacent receiver element, said receiver element being disposed on said second side of said transfer layer when said light-to-heat conversion layer is selectively exposed to light.

In the present invention, the support layer and transfer layer sandwich the light-to-heat conversion layer. Donor elements may optionally include other layers, for example disposed between the support layer and the transfer layer (e.g. an interlayer), on the first side of the support layer (e.g. an antistatic layer), and on the second side of the transfer layer opposite the light-to-heat conversion layer (e.g. an adhesive layer).

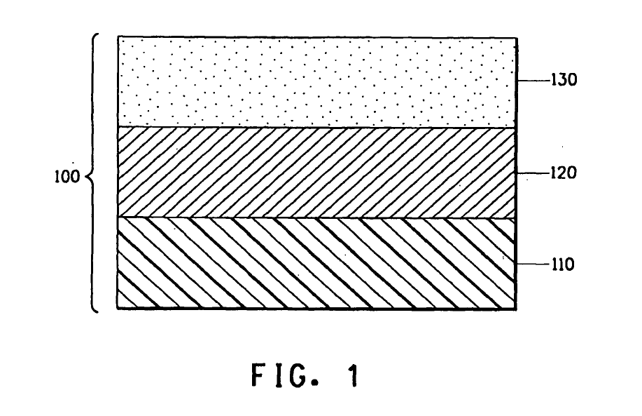

FIG. 1 shows a donor element 100 comprising a support layer 110, a light-to-heat conversion (LTHC) layer 120, and a transfer layer 130. In the present invention, a maleic anhydride-based polymer is disposed within the light-to-heat conversion layer 120 in FIG. 1.

The Support Layer

The support layer 110 provides a practical means of handling the donor element with its functional layers, for example during manufacturing, in making the imagable assemblage, and in removing the spent donor element from the imaged receiver element after imaging of the assemblage. In such aspects, the support layer is conventional, acting as a substrate for layers that may be substantially changed during imaging (for example, created, moved, decomposed, melted, etc.).

The support layer 110 can be a polymer film. One suitable type of polymer film is a polyester film, for example, polyethylene terephthalate or polyethylene naphthalate film. However, other films with sufficient mechanical and thermal stability for the particular application, and optionally, sufficient optical properties, including high transmission of light at a particular wavelength, can be used. Examples of suitable polymers for a support layer include polycarbonate, polyolefin, polyvinyl resin, or polyester. In one embodiment, synthetic linear polyester is used for the support layer.

Synthetic linear polyesters useful as the support layer may be obtained by condensing one or more dicarboxylic acids or their lower alkyl (up to 6 carbon atoms) diesters, e.g., terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydro-terephthalic acid or 1,2-bis-p-carboxyphenoxyethane (optionally with a monocarboxylic acid, such as pivalic acid) with one or more glycols, particularly an aliphatic or cycloaliphatic glycol, e.g., ethylene glycol, 1,3-propanediol, 1,4-butanediol, neopentyl glycol and 1,4-cyclohexanedimethanol. An aromatic dicarboxylic acid is preferred. An aliphatic glycol is preferred. Polyesters or copolyesters containing units derived from hydroxycarboxylic acid monomers, such as ω-hydroxyalkanoic acids (typically C₃-C₁₂) such as hydroxypropionic acid, hydroxybutyric acid, p-hydroxybenzoic acid, m-hydroxybenzoic acid, or 2-hydroxynaphthalene-6-carboxylic acid, may also be used. In one embodiment, the polyester is selected from polyethylene terephthalate and polyethylene naphthalate.

The support layer may comprise one or more discrete layers of the above film-forming materials. The polymeric materials of the respective layers may be the same or different. For instance, the support layer may comprise one, two, three, four or five or more layers and typical multi-layer structures may be of the AB, ABA, ABC, ABAB, ABABA or ABCBA type.

Formation of the support layer may be accomplished by conventional techniques. Conveniently, formation of the support layer is effected by extrusion. In general terms the process may comprise the steps of extruding a layer of molten polymer, quenching the extrudate and orienting the quenched extrudate in at least one direction.

The support layer may be unoriented, or oriented any number of times, for example uniaxially-oriented, or biaxially-oriented. Orientation may be effected by any process known in the art for producing an oriented film, for example a tubular or flat film process. Biaxial orientation may be effected by drawing in two mutually perpendicular directions in the plane of the film to achieve a satisfactory combination of mechanical and physical properties.

Simultaneous biaxial orientation may be effected by extruding a thermoplastic polymer tube, which is subsequently quenched, reheated and then expanded by internal gas pressure to induce transverse orientation, and withdrawn at a rate, which will induce longitudinal orientation.

The support layer-forming polymer may be extruded through a slot die and rapidly quenched upon a chilled casting drum to ensure that the polymer is quenched to the amorphous state. Orientation then may be effected by stretching the quenched extrudate in at least one direction at a temperature above the glass transition temperature of the polyester. Sequential orientation may be effected by stretching a flat, quenched extrudate firstly in one direction, usually the longitudinal direction, i.e. the forward direction through the film-stretching machine, and then in the transverse direction. Forward stretching of the extrudate may be conveniently effected over a set of rotating rolls or between two pairs of nip rolls, transverse stretching then being effected in a stenter apparatus. Alternatively, the cast film may be stretched simultaneously in both the forward and transverse directions in a biaxial stenter. Stretching is effected to an extent determined by the nature of the polymer, for example polyethylene terephthalate is usually stretched so that the dimension of the oriented film is from 2 to 5, more preferably 2.5 to 4.5, times its original dimension in each direction of stretching. Typically, stretching is effected at temperatures in the range of 70 to 125° C. Greater draw ratios (for example, up to about 8 times) may be used if orientation in only one direction is required. It is not necessary to stretch equally in each direction although this is common.

Where the support layer itself comprises more than one layer, preparation of the support layer may be conveniently effected by coextrusion, either by simultaneous coextrusion of the respective film-forming layers through independent orifices of a multi-orifice die, and thereafter uniting the still molten layers, or, alternately, by single-channel coextrusion in which molten streams of the respective polymers are first united within a channel leading to a die manifold, and thereafter extruded together from the die orifice under conditions of streamline flow without intermixing thereby to produce a multi-layer polymeric film, which may be oriented and heat-set as herein described. Formation of a multi-layer support layer may also be effected by conventional lamination techniques, for example by laminating together a preformed first layer and a preformed second layer, or by casting, for example, the first layer onto a preformed second layer.

The support layer is typically thin and coatable so that uniform coatings can be conveniently applied and concentrated into subsequent layers, and the final multilayer donor element can be conveniently handled in sheet or roll form. The support layer composition is also typically selected from materials that remain stable despite heating of the light-to-heat conversion layer during imaging. The typical thickness of the support layer may range from about 0.005 to about 0.5 mm, for example about 15 μm, about 25 μm, about 50 μm, about 100 μm, or about 250 μm thick film, although thicker or thinner support layers may be used. The width and length dimensions of the support layer are chosen for convenience of handling and for dimensions of the receiver element to be imaged, for example a width of from about 0.1 to about 5 m, and a length of from about 0.1 to about 10,000 m.

The materials used to form the outmost surfaces on the second side of the support layer that contact the closest adjacent layer (e.g., an underlayer or a light-to-heat conversion layer) can be selected to improve adhesion between the support layer and the adjacent layer, to control temperature transport between the support layer and the adjacent layer, to control imaging light transport to the light-to-heat conversion layer, to improve handling of the donor element, and the like. An optional priming layer can be used to increase uniformity during the coating of subsequent layers onto the support layer and also increase the bonding strength between the support layer and adjacent layers. One example of a suitable support layer with primer layer is available from Teijin Ltd. (Product No. HPE100, Osaka, Japan).

The support layer may be plasma-treated to accept an adjacent contiguous layer, such as the MELINEX® line of polyester films made by DuPont Teijin Films®, a joint venture of DuPont and Teijin Limited. Backing layers on first side of the support layer may optionally be provided on the support. These backing layers may contain fillers to provide a roughened surface on the first side (back side) of the support layer, i.e., the side opposite from the transfer layer. Alternatively, the support layer itself may contain fillers incorporated into the support layer matrix, such as silica, to provide a roughened surface on first side (the back side) of the support layer. Alternatively, the support layer may be physically roughened to provide a roughened surface on one or both surfaces of the support layer. Some examples of physical roughening methods include sandblasting, impacting with a metal brush, etc. A light attenuated layer may result from a roughened support layer surface or surface layer, which can also include a light-attenuating agent such as an absorber or diffuser.

The support layer may contain any of the additives conventionally employed in the manufacture of polymeric films, such as voiding agents, lubricants, anti-oxidants, radical scavengers, UV absorbers, fire retardants, thermal stabilizers, anti-blocking agents, surface active agents, slip aids, optical brighteners, gloss improvers, pro-degradents, viscosity modifiers and dispersion stabilizers. Fillers are particularly common additives for polymeric film and useful in modulating film characteristics, as is well-known in the art. Typical fillers include particulate inorganic fillers (such as metal or metalloid oxides, clays and alkaline metal salts, such as the carbonates and sulfates of calcium and barium) or incompatible resin fillers (such as polyamides and polyolefins) or a mixture of two or more such fillers, as are well-known in the art and described in WO-03/078512-A for example, that is herein incorporated by reference. The components of the composition of a layer may be mixed together in a conventional manner. For example, by mixing with the monomeric reactants from which the layer polymer is derived, or the components may be mixed with the polymer by tumble or dry blending or by compounding in an extruder, followed by cooling and, usually, comminution into granules or chips. Masterbatching technology may also be employed.

The support layer is preferably unfilled or only slightly filled, i.e. any filler is present in only small amounts, generally not exceeding 0.5% and preferably less than 0.2% by weight of the support layer polymer. In this embodiment, the support layer will typically be optically clear, preferably having a percentage of scattered visible light (haze) of less than about 6%, more preferably less than about 3.5% and particularly less than about 2%, measured according to the standard method ASTM D 1003.

Metallized films can be used as a support layer for a donor element. Specific examples include single or multilayer films comprising polyethylene terephthalate or polyolefin films. Useful polyethylene terephthalate films include MELINEX® 473 (100 μm thickness), MELINEX® 6442 (100 μm thickness), MELINEX® LJX111 (25 μm thickness), and MELINEX® 453 (50 μm thickness), all metallized to 50% visible light transmission with metallic chromium by CP Films, Martinsville, Va.

The support layer is usually reasonably transparent to the imaging light, which impinges on it prior to reaching the light-to-heat conversion layer, for example a support layer having a light transmittance at the imaging wavelengths of about 90% or more. The support layer can be a single layer or a multilayer. Also, an antireflection layer may be formed generally on the first side of the support layer to reduce light reflection.

Light-to-Heat Conversion Layer

During the imaging step, as shown in FIG. 1, the light-to-heat conversion (LTHC) layer 120 acts to convert the light absorbed by one or more light absorbers to thermal energy, in at least the light-to-heat conversion layer. This thermal energy is sufficient to cause transfer of some component or a volume of the transfer layer to a receiver element of the assemblage. The receiver element of the assemblage is described later in this specification. A reference to a light absorber in this application means at least one light absorber. In other words, a light absorber can be one light absorber of substantially similar chemical composition or a combination of more than one light absorber.

Typically, a light absorber in the light-to-heat conversion layer absorbs light in the infrared, visible, and/or ultraviolet regions of the electromagnetic spectrum and converts the absorbed light into heat. The light absorber is typically highly absorptive of the selected imaging light, providing a light-to-heat conversion layer with an absorbance at the wavelength of the imaging light in the range of about 0.1 to about 3 or higher (approximately absorption of 20 to 99.9% or more of incident light at a specific wavelength). Typically the absorbance of the light-to-heat conversion layer at the wavelength of the imaging light is around 0.1, 0.2, 0.3, 0.4, 0.6, 0.8, 1.0, 1.25, 1.5, 2, 2.5, or 10 or somewhere in between, or larger.

“Absorbance” is the absolute value of the logarithm (base 10) of the ratio of a) the intensity of light transmitted through the layer (typically in the shortest direction) and b) the intensity of light incident on the layer. For example, an absorbance of 1 corresponds to transmission of approximately 10% of incident light intensity; an absorbance of greater than 0.4 corresponds to transmission of less than approximately 39.8% of incident light intensity.

In one embodiment, although the light-to-heat conversion layer is highly absorptive of light in the wavelength region or specific wavelength used for imaging, the light-to-heat conversion layer is much less absorptive (e.g. transparent, semitransparent, or translucent) in another wavelength region or specific wavelength. For example, an light-to-heat conversion layer imaged with a laser having maximum output around 830 nm can have an absorbance maximum in the wavelength region from 750 to 950 nm, white simultaneously having a absorbance maximum in the region from 400 to 750 nm that is at least 5 times smaller (e.g., the highest absorbance from 750 to 900 nm is at 840 nm, and absorbance (840 nm) is 0.5, while the highest absorbance from 400 to 750 is at 650 nm, and absorbance (650 nm) is 0.09).

In one embodiment, this regional ratio of absorbance of the imaging region to the non-imaging region typically will be greater than 1 so that the non-imaging region is relatively transparent; for example a ratio greater than a selection from 2, 4, 8, 12, 16, 32, or greater. This ratio of absorbance at given wavelength regions can be applied to the light-to-heat conversion layer, and also to any significant absorber in the light-to-heat conversion layer (for example, any specific absorber such as one accounting for at least 10% of the absorption of the imaging light can be characterized by the ratio, e.g., 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, (1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1]).

In one embodiment, the light-to-heat conversion layer is notably absorptive of light at certain imaging wavelengths, but is notably transmissive of light at some other wavelength. For example in one prophetic embodiment, while absorbing 90% of light at 832 nm in wavelength (absorbance 1 at a wavelength used for imaging by an infrared laser), only 20.6% of light at 440 nm in wavelength would be absorbed (absorbance 0.10, at a blue wavelength), allowing the donor to transmit far more light at a visible wavelength than at an imaging wavelength of the infrared. The ratio of absorbance (imaging wavelength to other wavelength) in that case is 10.

Transmission at the non-imaging wavelength need not be complete, but should be improved; an absorbance ratio varying from as low as 3 to as high as 100, or higher, can be useful. For example in visual inspections, a ratio favoring a visible wavelength for the selectively transmitted wavelength, selected from ratios of 5, 10, 15, 30, and 60 or higher should be useful. Useful wavelengths for transmission of light through light-to-heat conversion layer include 300 and 350 nm in the ultraviolet spectrum, 400, 450, 500, 550, 600, 650, 670, 700, and 750 nm in the visible spectrum, and 770, 800, 850, 900, 1000, and 1200 nm in the infrared spectrum. Useful wavelengths for absorbance to generate heat include wavelengths such as 671, 780, 785, 815, 830, 840, 850, 900, 946, 1047, 1053, 1064, 1313, 1319, and 1340 nm, corresponding, for example, to laser output wavelengths. A layer transmitting 20% or more of light at a given wavelength can be said to be (relatively) transparent at that wavelength. Transparency improves as transmission improves, e.g., from 20 to 30 to 40 to 50 to 60 to 70 to 80 to 90 to 95% or higher transmission at a given wavelength, transparency improves in a light-to-heat conversion layer. Scattering of light should also be minimized to improve transparency by minimizing backscatter and scattering losses.

The use of a highly absorptive material for the imaging radiation allows a very thin light-to-heat conversion layer to be constructed. A thin light-to-heat conversion layer can be useful in producing high localized temperatures by light absorption. In one embodiment, the thickness of the light-to-heat conversion layer is equal to or less than about 500 nm. Other useful thicknesses include less than or equal to about 400 nm, about 300 nm, about 200 nm, about 150 nm, about 100 nm, about 75 nm, about 50 nm, and about 30 nm.

Although thinner light-to-heat conversion layers are preferred, thicker layers can also be used, commonly up to about 5 μm in thickness. For example, in one embodiment, the thickness of a typical light-to-heat conversion layer ranges from 50 nm to 250 μm. Thickness is easily optimized by experiment. Sometimes, very thin films may not achieve a suitably high and constant amount of light absorption. In order to achieve a manageable amount of thermal energy and temperature during the imaging process, the thickness is typically varied according to the concentration and effectiveness of the light absorbers present. This allows for a necessary transfer of material from the transfer layer on to the receiving layer, without deleterious side effects.

It is often useful to select a light absorber that can absorb a significant amount of light with only a thin light-to-heat conversion layer. For example, if an light-to-heat conversion layer of 0.2 μm thickness has an absorbance of 0.2 for light at a wavelength of 830 nm, the layer can be said to have an absorbance coefficient of 1/μm, at 830 nm. In one embodiment, the light-to-heat conversion layer has at least one absorbance coefficient between two choices from 0.01, 0.1, 0.5, 1.0, 2.0, 4, 8, 16, 32, 64, and 125/μm at a wavelength between 750 and 1400 nm. In one embodiment, the light absorber in the light-to-heat conversion layer contributes more than 0.1 units of the absorbance for at least one wavelength in at least one of the visible, short wavelength mid-infrared, and long wavelength mid-infrared wavelength bands of light.

The light-to-heat conversion layer further comprises one or more maleic anhydride-based polymer. It should also be noted that the light-to-heat conversion layer may also comprise other polymers, copolymers, blends of polymers, and mixtures of polymers.

### Maleic Anhydride-Based Polymers

The donor element comprises a maleic anhydride-based polymer in the light-to-heat conversion layer.

Maleic anhydride-based polymer includes:
(1) maleic anhydride homopolymer;
(2) maleic acid homopolymer;
(3) fumaric acid homopolymer;
(4) homopolymer of monoester of maleic acid;
(5) homopolymer of monoester of fumaric acid;
(6) maleic anhydride copolymers;
(7) maleic acid copolymers;
(8) fumaric acid copolymers;
(9) copolymers of monoester of maleic acid; and
(10) copolymers of monoester of fumaric acid.

The term “maleic anhydride-based polymer” encompasses a polymer including at least one repeat unit equivalent to that provided by addition polymerization of one of maleic anhydride, maleic acid, fumaric acid, a monoester of maleic acid, and a monoester of fumaric acid. These repeat units are called maleic anhydride repeat unit, maleic acid repeat unit, fumaric acid repeat unit, monoester of maleic acid repeat unit, and monoester of fumaric acid repeat unit, respectively.

The term “maleic anhydride homopolymer” encompasses maleic anhydride-based polymer having a maleic anhydride repeat unit with less than 5% by weight of any repeat unit equivalent to that provided by addition polymerization of another monomer that is not maleic anhydride.

The term “maleic anhydride copolymer” encompasses maleic anhydride-based polymer with more than or equal to 5% by weight of any repeat unit equivalent to that provided by addition polymerization of another monomer that is not maleic anhydride.

The term “maleic acid homopolymer” encompasses maleic anhydride-based polymer having a maleic acid repeat unit with less than 5% by weight of any repeat unit equivalent to that provided by addition polymerization of another monomer that is not maleic acid.

The term “maleic acid copolymer” encompasses maleic anhydride-based polymer with more than or equal to 5% by weight of any repeat unit equivalent to that provided by addition polymerization of another monomer that is not maleic acid.

The term “fumaric acid homopolymer” encompasses maleic anhydride-based polymer having a fumaric acid repeat unit with less than 5% by weight of any repeat unit equivalent to that provided by addition polymerization of another monomer that is not fumaric acid.

The term “fumaric acid copolymer” encompasses maleic anhydride polymer with more than or equal to 5% by weight of any repeat unit equivalent to that provided by addition polymerization of another monomer that is not fumaric acid.

The term “homopolymer of monoester of maleic acid” encompasses maleic anhydride-based polymer having a monoester of maleic acid repeat unit with less than 5% by weight of any repeat unit equivalent to that provided by addition polymerization of another monomer that is not a monoester of maleic acid.

The term “copolymer of monoester of maleic acid” encompasses maleic anhydride polymer with more than or equal to 5% by weight of any repeat unit equivalent to that provided by addition polymerization of another monomer that is not a monoester of maleic acid.

The term “homopolymer of monoester of fumaric acid” encompasses maleic anhydride-based polymer having a monoester of fumaric acid repeat unit with less than 5% by weight of any repeat unit equivalent to that provided by addition polymerization of another monomer that is not a monoester of fumaric acid.

The term “copolymer of monoester of fumaric acid” encompasses maleic anhydride polymer with more than or equal to 5% by weight of any repeat unit equivalent to that provided by addition polymerization of another monomer that is not a monoester of fumaric acid.

In preferred embodiments, the maleic anhydride-based polymer can also include one or more repeat units equivalent to that provided by the addition polymerization of additional ethylenically unsaturated monomers. Exemplary ethylenically unsaturated monomers include those having at least one free hydrogen on the carbon atom that becomes directly attached to the recurring unit of the three different configurations described below, during polymerization. Representative useful monomers include, but are not limited to, vinyl alkyl ethers, styrenes, vinyl acetate, ethylene, propylene, 1,3-butadiene, and isobutylene. Preferably, such monomers have two hydrogens attached to the carbon that becomes directly attached to the recurring unit of the three configurations discussed below. However, if one or both of those hydrogen atoms are replaced with a substituent, that substituent preferably has no more than 10 carbon atoms, and more preferably, it has no more than 6 carbon atoms, and further preferably, no more than 3 carbon atoms, so as to limit the oleophilicity contributed to the copolymer by that monomer. Various substituents include, but are not limited to, methyl, ethyl, isopropyl, acetyl, ethenyl, acetoxy, methoxy, ethoxy and styrene. More than one additional monomer can be copolymerized and incorporated into the copolymer.

Particularly useful monomers include, but are not limited to, ethylene, 1,3-butadiene, vinyl acetate, styrene, vinyl methyl ether and vinyl ethyl ether or any combination thereof. Ethylene, 1,3-butadiene and vinyl acetate are more preferred, and ethylene is further preferred. Thus, in an exemplary embodiment, a further preferred copolymer is derived from maleic anhydride and ethylene, in a substantially equimolar basis (from about 40 mol % to about 60 mol % of maleic anhydride).

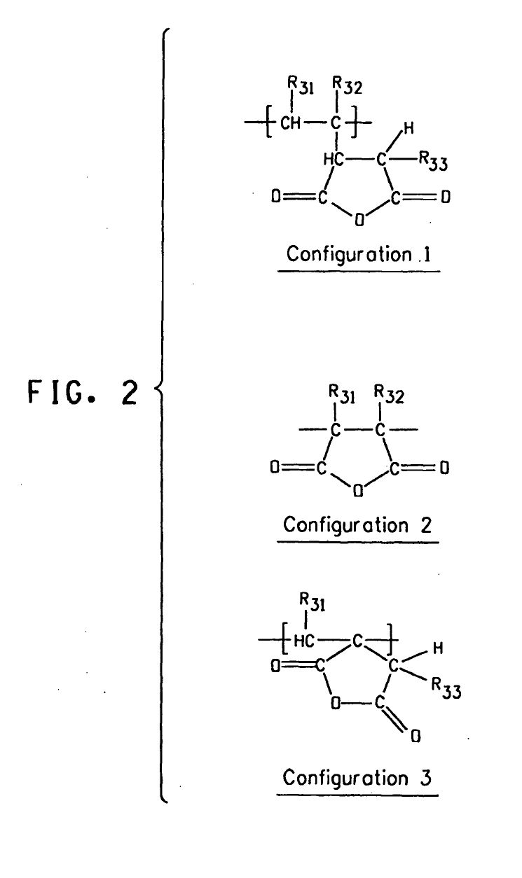

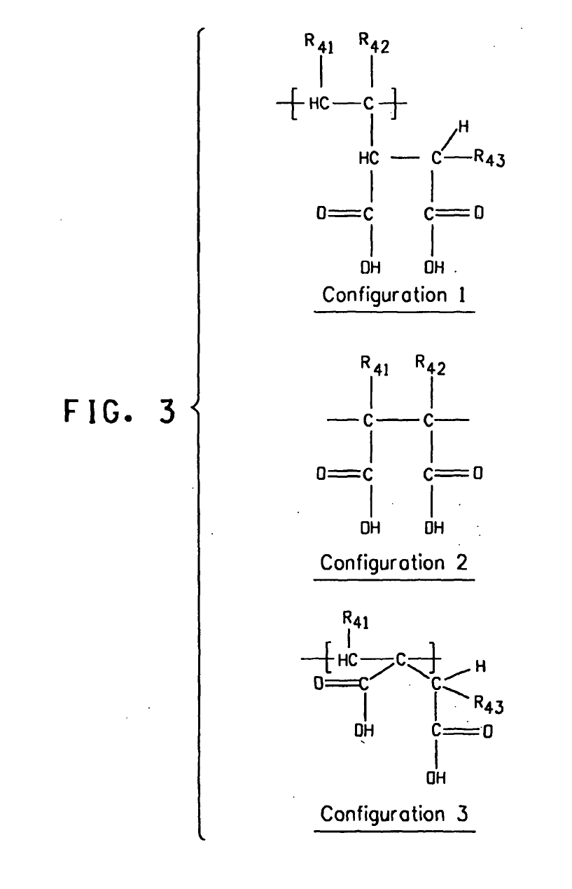

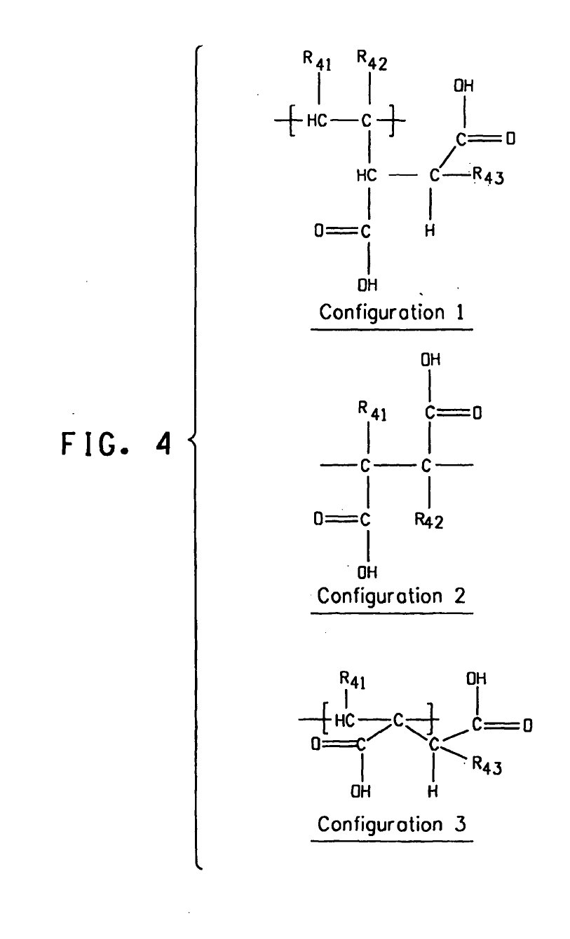

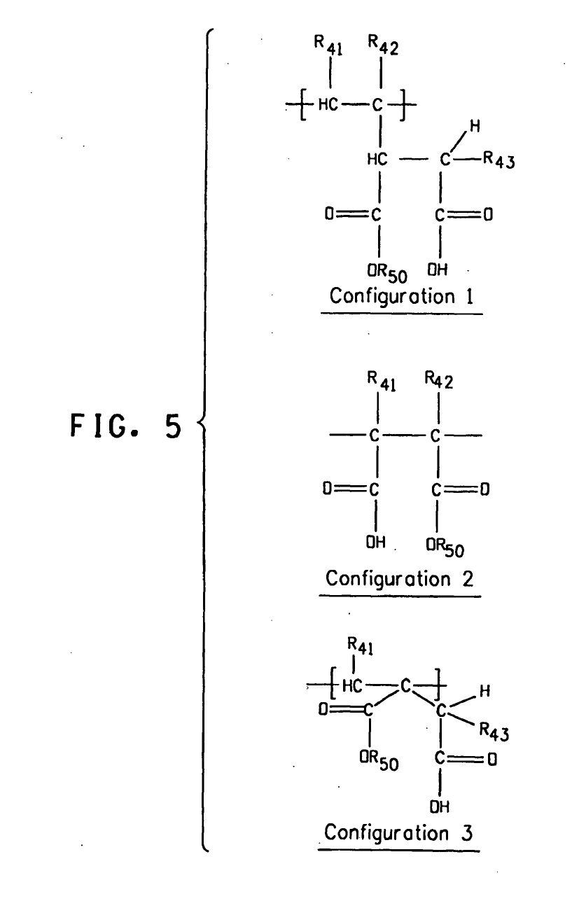

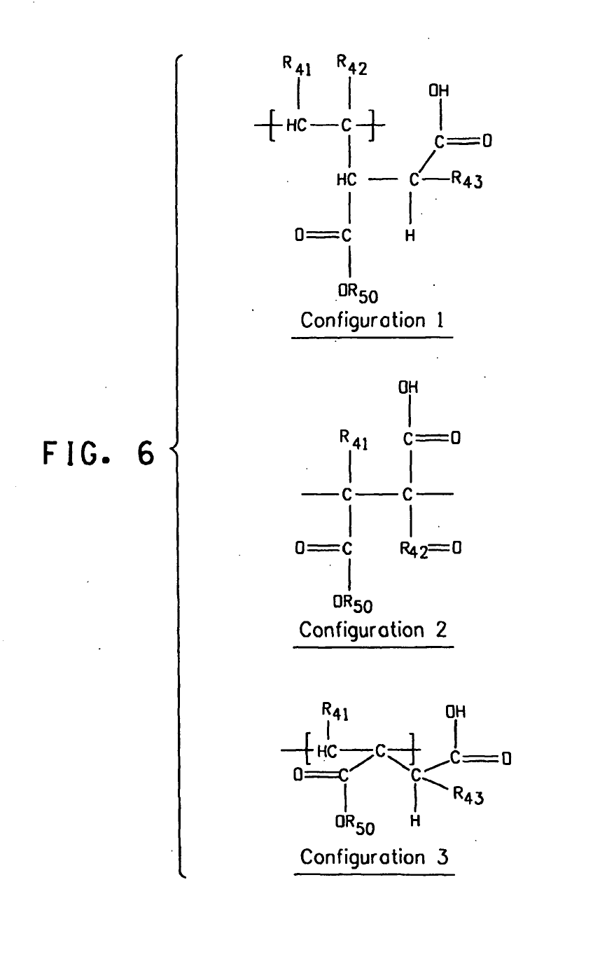

The repeat units defined above can be present in the three different configurations depicted in FIGS. 2-6. FIG. 2 corresponds to maleic anhydride repeat unit. FIG. 3 corresponds to maleic acid repeat unit. FIG. 4 corresponds to fumaric acid repeat unit. FIG. 5 corresponds to monoester of maleic acid repeat unit. FIG. 6 corresponds to monoester of fumaric acid repeat unit.

Each Figure depicts the three configurations corresponding to the particular repeat unit.

By configuration 1 is meant that none of the two carbons (alpha carbons) bonded to the two carbonyl groups are part of the backbone of the maleic anhydride-based polymer, and one of the two carbons is pendant to a carbon in the backbone of the maleic anhydride-based polymer.

By configuration 2 is meant that the two carbons (alpha carbons) bonded to the two carbonyl groups are both part of the backbone of the maleic anhydride-based polymer.

By configuration 3 is meant that only one of the two carbons (alpha carbons) bonded to the two carbonyl groups is part of the backbone of the maleic anhydride-based polymer.

A maleic anhydride-based polymer of the present invention has at least one of the three configurations.

In the structures of FIGS. 2-6:

R₃₁, R₃₂ and R₃₃ are the same or different groups, which can be hydrogen or alkyl of one to about five carbon atoms. Preferably, R₃₁, R₃₂ and R₃₃ individually are hydrogen or methyl;

R₄₁, R₄₂ and R₄₃ are the same or different groups, which can be hydrogen or alkyl of one to about five carbon atoms. Preferably, R₄₁, R₄₂ and R₄₃ individually are hydrogen or methyl; and

R₅₀ can be any organic functional group. For example, it can be alkyl, aralkyl, alkyl-substituted aralkyl radicals containing from one to about twenty carbon atoms, and oxyalkylated derivatives of such radicals containing from about two to about four carbon atoms in each oxyalkylene group, which can be of one to about twenty repeating units, preferably one to about six repeating units. In some embodiments, R₅₀ can include one or more unsaturated moieties and/or one or more heteroatom moieties. R₅₀ can also be other small molecules that are not organic, for example, alkaline molecules capable of forming salts if an anhydride is formed. Such alkaline molecules include Li, Na, K and NH₄⁺. Such salts can be present as a cation with a carboxylate anion, for example, —COONa⁺, —COOLi⁺, COOK⁺, and COONH₄⁺.

In a preferred embodiment, the maleic anhydride-based polymer includes repeat units equivalent to those derived from styrene or a styrene derivative, for example, styrene-maleic anhydride polymer. The term “styrene-maleic anhydride polymer” encompasses maleic anhydride-based polymer additionally including at least one repeat unit equivalent to that provided by addition polymerization of one of styrene and styrene derivatives. In a preferred embodiment, the styrene derivative is a styrene alkyl derivative such as alpha-methyl styrene or 4-methyl styrene.

Preferably, the styrene-maleic anhydride polymer is a monoester copolymer of styrene and maleic anhydride.

Suitable monoester copolymer of styrene and maleic anhydride include, but are not limited to, copolymers represented by Formula I below:

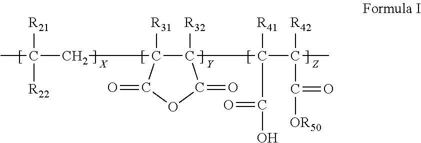

wherein x and z are any positive integer, such as 1, 2, 3, 4, 5, 6, 7, 8, 9, 10, . . . 20, . . 30, 40, 50, 60, 70, 80, 90, 100, etc., y is zero or any positive integer, such as 1, 2, 3, 4, 5, 6, 7, 8, 9, 10, 20, 30, 40, 50, 60, 70, 80, 90, 100, etc. Such copolymers can be block copolymers, alternating copolymers, or random copolymers.

In this formula, R₂₁ and R₂₂ can be the same or different, and individually are hydrogen, alkyl, aryl, aralkyl, cycloalkyl of one to ten carbon atoms, and halogen (such as chlorine, fluorine, or bromine), provided that one of R₂₁ and R₂₂ is an aromatic group, such as phenyl or a substituted phenyl group. Preferably, R₂₁ and R₂₂, individually are hydrogen, methyl, phenyl, benzyl, or cycloalkyl of four to six carbon atoms.

R₃₁ and R₃₂ and R₄₁ and R₄₂ are the same or different groups, which can be hydrogen or alkyl of one to about five carbon atoms. Preferably, R₃₁ and R₃₂, and R₄₁, and R₄₂ individually are hydrogen or methyl.

R₅₀ can be any organic functional group. For example, it can be alkyl, aralkyl, alkyl-substituted aralkyl radicals containing from one to about twenty carbon atoms, and oxyalkylated derivatives of such radicals containing from about two to about four carbon atoms in each oxyalkylene group, which can be of one to about twenty repeating units, preferably one to about six repeating units. In some embodiments, R₅₀ can include one or more unsaturated moieties and/or one or more heteroatom moieties. R₅₀ can also be other small molecules that are not organic, for example, alkaline molecules capable of forming salts if an anhydride is formed. Such alkaline molecules include Li, Na, K and NH₄⁺.

Although the monoester copolymer is illustrated as block copolymer with three blocks of repeating units, the monoester copolymer need not be a block copolymer. For example, the three repeating units can be randomly distributed throughout the backbone of the polymer chains. It can also be an alternating copolymer.

The use of the term “monoester” does not preclude the presence of diester functionality and/or maleic anhydride functionalities. In some embodiments, suitable copolymers can be a mixture of a monoester copolymer of styrene and maleic anhydride and a diester copolymer of styrene and maleic anhydride. The term “copolymer of styrene and maleic anhydride” or “styrene and maleic anhydride copolymer” refer to a class of copolymers obtained by copolymerizing styrene or its derivatives with maleic anhydride or its derivatives. Therefore, the term refers not only to the copolymer obtained from styrene and maleic anhydride, but also to derivatives of the styrene and maleic anhydride copolymer family.

In general, the monoester copolymers of styrene and maleic anhydride can be liquids or free flowing solids such as granular, pellet, or powder suitable for dispersing into the light-to-heat conversion layer, depending upon their molecular weight. These monoester copolymers are characterized by their number average molecular weight (Mₙ), their weight average molecular weight (M_{w}), their acid number, and their glass transition temperature (T_{g}). Specifically, they are characterized by a number average molecular weight of about 500 to about 20,000, preferably about 1,000 to about 10,000, more preferably about 2000 to about 7000, and preferably about 6200. The monoester copolymers of the invention are further characterized by a weight average molecular weight of about 1,000 to 30,000, preferably about 5,000 to about 20,000, and more preferably about 15,000. The monoesters also possess a glass transition temperature of about 30° C. to about 150° C., preferably about 40° C. to about 150° C., and more preferably about 150° C.

Suitable monoester copolymers can be obtained by reacting a suitable alcohol with a styrene maleic anhydride copolymer (“SMA copolymers”). They can also be prepared by copolymerization of appropriate monomers without further reactions. Any SMA copolymers can be used to react with an alcohol.

Alcohol compounds which can be reacted with an SMA copolymer to form the ester functionality include, but are not limited to, C_{g} or greater primary, secondary, and tertiary alcohols, including but not limited to, hexanol, isohexanol, 2-ethylhexanol, t-octanol, isooctanol, decanol, octadecanol (lauryl alcohol), tetradecyl alcohol, cetyl alcohol, oleyl alcohol, stearyl alcohol, and nonylbenzyl alcohol, as well as oxyalkylene derivatives of such alcohols wherein at least 1,2-alkylene oxide, such as ethylene oxide, 1,2-propylene oxide, and 1,2-butylene oxide, has been condensed therewith. Moreover, alcohols containing unsaturated moieties and/or heteroatom moieties can also be used to esterify a SMA copolymer. It should be understood that the above description with respect to suitable monoester copolymers of styrene and maleic anhydride is merely exemplary. Bases such as NaOH, LiOH, KOH and NH₄OH can also be used.

Monoester copolymers of SMA encompass those referred to in the art as partial monoesters of styrene maleic anhydride copolymers and fatty alcohols (“MSMA's”), including but not limited to, MSMA's and derivatives of MSMA's (such as sodium salts of sulfonated MSMA's). Such compounds are typically available in resin form, and can be utilized in embodiments of the present invention by direct combination with other components in an aqueous fluid, or by prior dissolution in an aqueous-based solvent.

Among suitable MSMA-based compounds are those compounds formed from styrene maleic anhydride copolymers. In some embodiments, m (styrene repeat unit) ranges from about 1 to about 3; n (copolymer repeat unit) ranges from about 6 to about 8. It should be understood that values of m and n can vary outside these ranges.

Suitable MSMA compounds include, but are not limited to, those formed by the esterification of styrene maleic anhydride copolymer with one or more fatty alcohols as

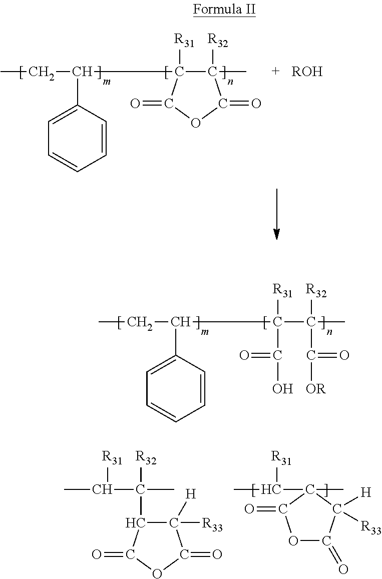

wherein m and n are defined above. In some embodiments, ROH (this is the alcohol for esterification) represents a fatty alcohol in which R is a branched or straight carbon chain that can be saturated or unsaturated, wherein the branched chain alcohol can contain at least one carboxyl functionality, and which can have from about 8 to about 20 carbon atoms, from about 10 to about 25 carbon atoms, or from about 6 to about 38 carbon atoms. The degree of esterification of such MSMA compounds can vary from relatively little to almost complete esterification, e.g., from about 15% to about 90%, and more preferably about 35% to about 90%.

Specific examples of fatty alcohols for MSMA esterification include, but are not limited to, those produced by the Ziegler, modified-Ziegler, Idemitsu and Oxo (cf. Ullmann's Encyclopedia of Industrial Chemistry, 5^{th} Ed, Vol. A1; pages 290-293) processes, reduction of vegetable oils and fatty acids with sodium, catalytic hydrogenation at elevated temperatures and pressures, and hydrolysis of spermacetia and sperm oil by saponification and vacuum fractional distillation. Specific examples of saturated fatty alcohols include, but are not limited to, octyl, decyl, lauryl, myristyl, cetyl and stearyl alcohols, etc. Specific examples of unsaturated fatty alcohols include, but are not limited to, oleyl alcohol, linoleyl alcohol, linolenyl alcohol, and the like.

Although some MSMA compounds described above are formed from monofunctional alcohols, it should be understood that MSMA compounds formed from multifunctional fatty alcohols (difunctional, trifunctional, branched, and the like) are also possible. Branched chain alcohols suitable for use in the MSMA compounds of the invention are meant to include, but not be limited by, those branched chain alcohols with carboxyl functionalities. It is also possible to use partial esters of styrene maleic anhydride and alcohols other than fatty alcohols. In addition, partial esters of styrene maleic anhydride can be formed with other organic carbon chains with one or more carboxyl functionalities formed thereon.

Derivatives of MSMA compounds can also be employed in addition to or in place of MSMA compounds. Examples of such MSMA derivatives include, but are not limited to, MSMA compounds with aryl groups that are substituted or partially substituted. In one embodiment, sulfonated MSMA derivatives formed with the following structure are used:

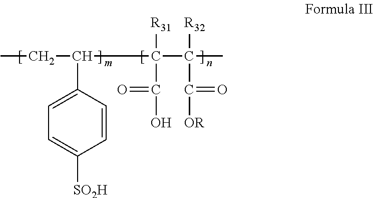

wherein m, n, and R are defined above for MSMA compounds.

It should be noted that derivitization and substitution reactions are shown for only one configuration, i.e., in which two carbon atoms of the backbone are used and for styrene-maleic anhydride polymers. However, the reaction scheme applies to other configurations, as well, and for other maleic anhydride-based polymers.

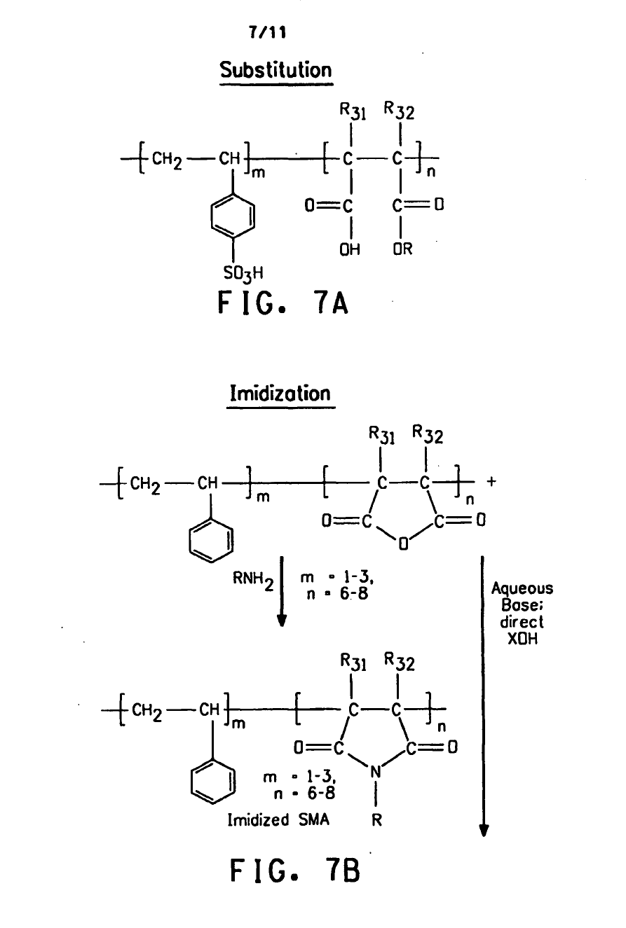

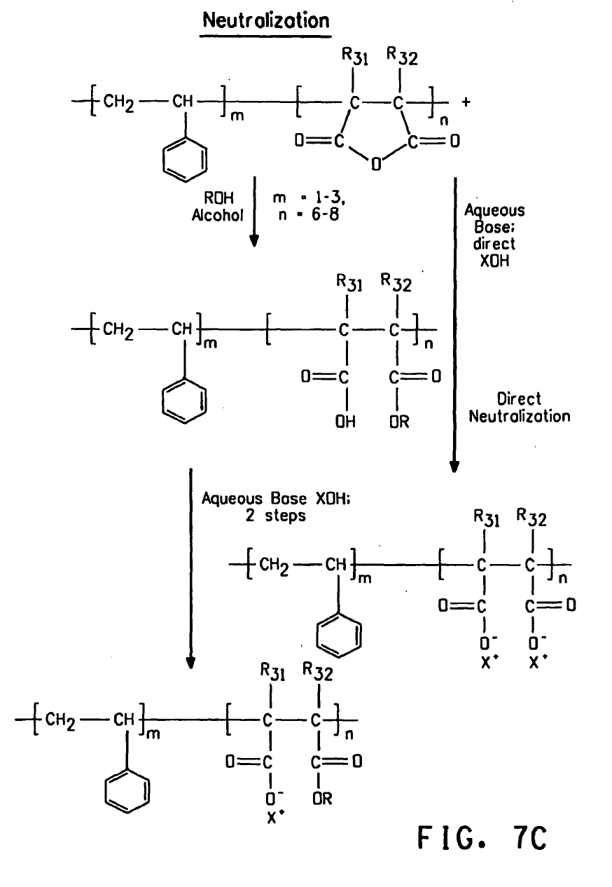

FIG. 7 shows exemplary reactions that a styrene maleic anhydride-based polymer may undergo, such as substitution, imidization, and neutralization.

The light-to-heat conversion layer or their precursors may be applied by any suitable technique for coating a material such as, for example, bar coating, gravure roll coating, extrusion coating, vapor deposition, lamination, reverse roll coating, dip coating, bead coating, slot coating, electrostatic spray coating and other such techniques.

Light Absorber Materials in the LTHC Layer

Suitable light absorbing materials for the light-to-heat conversion layer can include, for example, dyes (e.g., visible dyes, ultraviolet dyes, infrared dyes including near infrared dyes, fluorescent dyes, and radiation-polarizing dyes), pigments, metals, metal compounds, metal films, and other suitable absorbing materials.

Dyes suitable for use as light absorbers in a light-to-heat conversion layer may be present at least in part (>5%) in dissolved form, or in at least partially dispersed form, rather than practically entirely (>80%) in a particulate form as for pigments. In one embodiment, the light absorber most responsible for the absorbance at the imaging wavelengths is a dye completely or partially (>5%) dissolved in the light-to-heat conversion layer. In one embodiment, the light absorber most responsible for the absorbance at the imaging wavelengths is practically dissolved (>80%) in a formulation when applied to the donor element construction, and becomes partially dispersed later.

Examples of dyes and pigments suitable as light absorbers in a light-to-heat conversion layer include polysubstituted phthalocyanine compounds and metal-containing phthalocyanine compounds; metal-complex compounds, benzoxazole compounds, benz[e, f, or g]indolium compounds, indocyanine compounds, cyanine compounds; squarylium compounds; chalcogenopyryloacrylidene compounds; croconium and croconate compounds; metal thiolate compounds; bis(chalcogenopyrylo) polymethine compounds; oxyindolizine compounds; indolizine compounds; pyrylium and metal dithiolene compounds, bis(aminoaryl) polymethine compounds; merocyanine compounds; thiazine compounds; azulenium compounds; xanthene compounds; and quinoid compounds. Light absorbing materials disclosed in the following references are also suitable herein when used with an appropriate light source and are incorporated by reference:
(1) U.S. Pat. No. 5,108,873, “IR-ray absorptive compound and optical recording medium by use thereof”;
(2) U.S. Pat. No. 5,036,040, “Infrared absorbing nickel-dithiolene dye complexes for dye-donor element used in laser-induced thermal dye transfer”;
(3) U.S. Pat. No. 5,035,977, “Infrared absorbing oxonol dyes for dye-donor element used in laser-induced thermal dye transfer”;
(4) U.S. Pat. No. 5,034,303, “Infrared absorbing trinuclear cyanine dyes for dye-donor element used in laser-induced thermal dye transfer”;
(5) U.S. Pat. No. 5,024,923, “Infrared absorbent compositions”;
(6) U.S. Pat. No. 5,019,549, “Donor element for thermal imaging containing infra-red absorbing squarylium compound”;
(7) U.S. Pat. No. 5,019,480, “Infrared absorbing indene-bridged-polymethine dyes for dye-donor element used in laser-induced thermal dye transfer”;
(8) U.S. Pat. No. 4,973,572, “Infrared absorbing cyanine dyes for dye-donor element used in laser-induced thermal dye transfer”;
(9) U.S. Pat. No. 4,952,552, “Infrared absorbing quinoid dyes for dye-donor element used in laser-induced thermal dye transfer”;
(10) U.S. Pat. No. 4,950,640, “Infrared absorbing merocyanine dyes for dye-donor element used in laser-induced thermal dye transfer”;
(11) U.S. Pat. No. 4,950,639, “Infrared absorbing bis(aminoaryl)polymethine dyes for dye-donor element used in laser-induced thermal dye transfer”;
(12) U.S. Pat. No. 4,948,778, “Infrared absorbing oxyindolizine dyes for dye-donor element used in laser-induced thermal dye transfer”;
(13) U.S. Pat. No. 4,948,777, “Infrared absorbing bis(chalcogenopyrylo)polymethine dyes for dye-donor element used in laser-induced thermal dye transfer”;
(14) U.S. Pat. No. 4,948,776, “Infrared absorbing chalcogenopyrylo-arylidene dyes for dye-donor element used in laser-induced thermal dye transfer”;
(15) U.S. Pat. No. 4,942,141, “Infrared absorbing squarylium dyes for dye-donor element used in laser-induced thermal dye transfer”;
(16) U.S. Pat. No. 4,923,638, “Near infrared absorbing composition”;
(17) U.S. Pat. No. 4,921,317, “Infrared absorbent comprising a metal complex compound containing two thiolato bidentate ligands”;
(18) U.S. Pat. No. 4,913,846, “Infrared absorbing composition”;
(19) U.S. Pat. No. 4,912,083, “Infrared absorbing ferrous complexes for dye-donor element used in laser-induced thermal dye transfer”;
(20) U.S. Pat. No. 4,892,584, “Water soluble infrared absorbing dyes and ink-jet inks containing them”;
(21) U.S. Pat. No. 4,791,023, “Infrared absorbent and optical material using the same”;
(22) U.S. Pat. No. 4,788,128, “Transfer Printing Medium with Thermal Transfer Dye and Infra-Red Radiation Phthalocyanine Absorber”;
(23) U.S. Pat. No. 4,767,571, “Infrared absorbent”;
(24) U.S. Pat. No. 4,675,357, “Near infrared absorbing polymerizate”;
(25) U.S. Pat. No. 4,508,811, “Recording element having a pyrylium or thiopyrylium-squarylium dye layer and new pyrylium or thiopyrylium-squarylium compounds”;
(26) U.S. Pat. No. 4,446,223, “Recording and information record elements comprising oxoindolizine and oxoindolizinium dyes”;
(27) U.S. Pat. No. 4,315,983, “2,6-Di-tert-butyl-4-substituted thiopyrylium salt, process for production of same, and a photoconductive composition containing same”; and
(28) U.S. Pat. No. 3,495,987, “Photopolymerizable Products”.

A source of suitable infrared-absorbing dyes (including near-, mid-, and far-infrared absorbing dyes) is H. W. Sands Corporation, Jupiter, Fla. Suitable dyes include 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1], available from H. W. Sands Corp., as SDA-4927; 2-[2-[2-(2-pyrimidinothio)-3-[2-(1,3-dihydro-1,1-dimethyl-3-(4-sulfobutyl)-2H-benz[e]indol-2-ylidene)]ethylidene-1-cyclopenten-1-yl]ethenyl]-1,1dimethyl-3-(4-sulfobutyl)-1H-benz[e]indolium, inner salt, sodium salt, having molecular formula C₄₁H₄₇N₄Na₁O₆S₃ and molecular weight of about 811 g/mole, available from H. W. Sands Corp., as SDA-5802; indocyanine green, having CAS No. [3599-32-4] C₄₃H₄₇N₂Na₁O₆S₂, and molecular weight of about 775 g/mole, available from H. W. Sands Corp., as SDA-8662; 3H-indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with trifluoromethanesulfonic acid (1:1) having CAS No. [128433-68-1] and molecular weight of about 619 g/mole, available from Hampford Research, Inc, Stratford, Conn.; or Pisgah Laboratories, Pisgah Forest, N.C. as TIC-5C. Examples of other such dyes may be found in Matsuoka, M., Infrared Absorbing Materials, Plenum Press, New York, 1990, and in Matsuoka, M., Absorption Spectra of Dyes for Diode Lasers, Bunshin Publishing Co., Tokyo, 1990. IR absorbers marketed by American Cyanamid Co., Wayne, N.J.; Cytec Industries, West Paterson, N.J. or by Glendale Protective Technologies, Inc., Lakeland, Fla., under the designation CYASORB IR-99 (CAS No. [67255-33-8]), IR-126 (CAS No. [85496-34-0]) and IR-165 (N,N′-2,5-cyclohexadiene-1,4-diylidenebis[4-(dibutylamino)-N-[4 (dibutylamino)phenyl]benzenaminium bis[(OC-6-11)-hexafluoroantimonate(1-)], CAS No. [5496-71-9]) may be used.

A specific dye may be chosen based on factors such as solubility in, and compatibility with, a specific binder and/or coating solvent of the light-to-heat conversion layer, as well as the wavelength ranges of absorption necessary, desired, undesired, and forbidden for the light-to-heat conversion layer.

Pigmentary materials may also be used in the light-to-heat conversion layer as light absorbers. Examples of suitable pigments include carbon black and graphite, as well as phthalocyanines, nickel dithiolenes, and other pigments. Additionally, black azo pigments based on copper or chromium complexes of, for example, pyrazolone yellow, dianisidine red, and nickel azo yellow are useful. Inorganic pigments are also valuable. Examples include oxides and sulfides of metals such as aluminum, bismuth, tin, indium, zinc, titanium, chromium, molybdenum, tungsten, cobalt, iridium, nickel, palladium, platinum, copper, silver, gold, zirconium, iron, lead or tellurium. Metal borides, carbides, nitrides, carbonitrides, bronze-structured oxides, and oxides structurally related to the bronze family are also of utility.

Another suitable light-to-heat conversion layer includes metal or metal/metal oxide formed as a thin film, for example, black aluminum (i.e., a partially oxidized aluminum having a black visual appearance) or chrome. Metallic and metal compound films may be formed by techniques such as, for example, sputtering and evaporative deposition. Particulate coatings may be formed using a binder and any suitable dry or wet coating techniques.

Materials suitable for the light-to-heat conversion layer can be inorganic or organic and can inherently absorb the imaging light or serve other purposes such as film formation or adhesion modification.

Examples of components in a suitable light-to-heat conversion layers that are insignificant light-to-heat converters at the wavelengths of interest, but aid in other functions, include typical binders, polymers, and coating aids such as surfactants, and minor light absorbers such as pigments and dyes with insignificant absorbance at the imaging light wavelengths.

Suitable binders for use in the light-to-heat conversion layer include film-forming polymers, such as for example, phenolic resins (i.e., Novolak™ and resole resins), polyvinyl butyral resins, polyvinylacetates, polyvinyl acetals, polyvinylidene chlorides, polyacrylates, cellulosic ethers and esters, nitrocelluloses, polyesters, sulfopolyesters, polystyrenes and polycarbonates. A preferred binder is polyester sulfonate, also known as Eastek 1200. When a binder is present, the light-to-heat converter-to-binder ratio may generally range from about 5:1 to 1:1000 by weight depending on what type of light-to-heat converters and binders are used. Conventional coating aids, such as surfactants and dispersing agents, may be added to facilitate the coating process. The light-to-heat conversion layer may be coated onto the support layer using a variety of coating methods known in the art. A binder-containing light-to-heat conversion layer is typically coated to a thickness of from about 10 nm to about 5000 nm, for example 10 nm, 100 nm, 300 nm, 1000 nm, or 5000 nm.

Although it is typical to have a single light-to-heat conversion layer, it is also possible to have more than one light-to-heat conversion layer, and the different layers can have the same or different compositions, as long as they all function as described herein. The main light-to-heat conversion layer of importance is that which contributes most significantly to imaging as a result of light-to-heat conversion-typically the layer that achieves the highest temperature during imaging. Other layers may have some slight absorbance of the original imaging beam intensity, but the minor or negligible contribution of the absorbance to the phenomenon of imaging by these layers means they would seldom be considered a light-to-heat conversion layer.

Preferably, the copolymer based on styrene and maleic anhydride is located in the main light-to-heat conversion layer. Said copolymer can also be dispersed in several light-to-heat conversion layers in varying degrees of concentration depending upon the effect on transfer during imaging.

In one embodiment, the donor element has a light-to-heat conversion layer having at least one particulate light absorber such as carbon black.

In one embodiment, the donor element includes a light-to-heat conversion layer having at least one non-particulate light absorber such as a dye. A benefit of a dissolved light absorber is that homogeneous layers without particle agglomeration can be formed, so that very thin layers absorb light homogeneously. Another benefit of a dissolved light absorber is that light scattering is less. It is possible for a dissolved light absorber to be accompanied by an undissolved form of the same light absorber. In one embodiment, the dissolved (non-particulate) form of a light absorber constitutes the majority by mass of that absorber.

In one embodiment, the donor element includes a light-to-heat conversion layer having at least one spectrum-selective non-particulate light absorber such as an infrared dye. A benefit of a spectrum-selective light absorber is that the absorbance spectrum can be selected for utility with the imaging light source, and the transmission spectrum can be selected for utility with a focusing laser or with inspection procedures by human or machine.

Transfer Layer

The transfer layer 130 of FIG. 1 serves to hold transferable material. In a typical donor element, there is at least one transfer layer. The transfer layer has a first side and the second side. The second side of said transfer layer is placed adjacent to a receiver element of an imagable assemblage for image-wise transfer by light. Transfer layers can include any suitable material or materials that are disposed in one or more layers with or without a binder that can be selectively transferred. The transfer can occur as a unit, in portions or in part by any suitable transfer mechanism. The transfer occurs when the donor element is exposed to imaging light that can be absorbed by the light-to-heat conversion layer and the electromagnetic light energy is converted into heat. In image-wise transfer, the transferred material need not be the entire mass of the transfer layer. Components of the transfer layer in a single portion may be selectively transferred to the receiver element while other components are retained with the donor element (e.g. a sublimable dye may transfer while a heat resistant crosslinked polymer matrix holding the dye may remain untransferred).

The transfer layer may be of any thickness, which remains functional for transfer to the receiver element and to fulfill the necessary function on the receiver element or the donor element. Typical thickness of a transfer layer may be from about 0.1 μm to about 20 μm; for example, 0.2, 0.5, 0.8, 1, 2, 4, 6, 8, 10, 15, or 20 μm.

The transfer layer may include multiple components including organic, inorganic, organometallic, or polymeric materials. Examples of materials that can selectively patterned from donor elements as transfer layers and/or as materials incorporated in transfer layers include colorants (e.g., pigments and/or dyes dispersed in a binder), polarizers, liquid crystal materials, particles (e.g., spacers for liquid crystal displays, magnetic particles, insulating particles, conductive particles), emissive materials (e.g., phosphors and/or organic electroluminescent materials), non-emissive materials that may be incorporated into an emissive device (for example, an electroluminescent device) hydrophobic materials (e.g., partition banks for ink-jet receptors), hydrophilic materials, multilayer stacks (e.g., multilayer device constructions such as organic electroluminescent devices), microstructured or nanostructured layers, etch-resist, metals, materials having a metal component, polymers, adhesives, binders, and bio-materials, and other suitable materials or combination of such materials.

The transfer layer can be coated onto the second side of the light-to-heat conversion layer, or other suitable donor element layer adjacent to the light-to-heat conversion layer. The transfer layer or its precursor may be applied by any suitable technique for coating a material such as, for example, bar coating, gravure coating, extrusion coating, vapor deposition, lamination and other such techniques. Prior to, after, or simultaneously with coating, a cross-linkable transfer layer material or portions thereof may be crosslinked, for example by heating, exposure to radiation, and/or exposure to a chemical curative, depending upon the material.

In one embodiment, the transfer layer includes material that is useful in display applications. Thermal transfer according to the present invention can be performed to pattern one or more materials on a receiver element with high precision and accuracy using fewer processing steps than for photolithography-based patterning techniques, and thus can be especially useful in applications such as display manufacture. For example, transfer layers can be made so that, upon thermal transfer to a receptor, the transferred materials form color filters, black matrix, spacers, barriers, partitions, polarizers, retardation layers, wave plates, organic conductors or semi-conductors, inorganic conductors or semi-conductors, organic electroluminescent layers, phosphor layers, organic electroluminescent devices, organic transistors, and other such elements, devices, or portions thereof that can be useful in displays, alone or in combination with other elements that may or may not be patterned in a like manner.

In particular embodiments, the transfer layer can include a colorant. Pigments or dyes, for example, may be used as colorants. In one embodiment, pigments having good color permanency and transparency such as those disclosed in the NPIRI Raw Materials Data Handbook, Volume 4 (Pigments), are used. Examples of suitable transparent colorants include Ciba-Geigy Cromophtal Red A2B®, Dainich-Seika ECY-204®, Zeneca Monastral Green 6Y-CL®, and BASF Heliogen Blue L6700®. Other suitable transparent colorants include Sun RS Magenta 234-007®, Hoechst GS Yellow GG 11-12000, Sun GS Cyan 249-0592®, Sun RS Cyan 248-061, Ciba-Geigy BS Magenta RT-333D®, Ciba-Geigy Microlith Yellow 3G-WA®, Ciba-Geigy Microlith Yellow 2R-WA®, Ciba-Geigy Microlith Blue YG-WA®, Ciba-Geigy Microlith Black C-WA®, Ciba-Geigy Microlith Violet RL-WA®, Ciba-Geigy Microlith Red RBS-WA®, any of the Heucotech Aquis II® series, any of the Heucosperse Aquis III series, and the like. Another class of pigments than can be used for colorants in the present invention are various latent pigments such as those available from Ciba-Geigy. Transfer of colorants by thermal imaging is disclosed in U.S. Pat. Nos. 5,521,035; 5,695,907; and 5,863,860 and is herein incorporated by reference.

In some embodiments, the transfer layer can include one or more materials useful in emissive displays such as organic electroluminescent displays and devices, or phosphor-based displays and devices. For example, the transfer layer can include a crosslinked light emitting polymer or a crosslinked charge transport material, as well as other organic conductive or semi-conductive materials, whether crosslinked or not. For organic light emitting diodes (OLEDs) that are polymeric, it may be desirable to crosslink one or more of the organic layers to enhance the stability of the final OLED device. Crosslinking one or more organic layers for an OLED device prior to thermal transfer may also be desired. Crosslinking before transfer can provide more stable donor media, better control over film morphology that might lead to better transfer and/or better performance properties in the OLED device, and/or allow for the construction of unique OLED devices and/or OLED devices that might be more easily prepared when crosslinking in the device layer(s) is performed prior to thermal transfer.

Examples of light emitting polymers include poly(phenylenevinylene)s (PPVs), poly-para-phenylenes (PPPs), and polyfluorenes (PFs). Specific examples of crosslinkable light emitting materials that can be useful in transfer layers of the present invention include the blue light emitting poly(methacrylate) copolymers disclosed in Li, et al., Synthetic Metals 84, pp. 437-438 (1997), the crosslinkable triphenylamine derivatives (TPAs) disclosed in Chen, et al., Synthetic Metals 107, pp. 203-207 (1999), the crosslinkable oligo- and poly(dialkylfluorene)s disclosed in Klarner, et al., Chem. Mat. 11, pp. 1800-1805 (1999), the partially crosslinked poly(N-vinylcarbazole-vinylalcohol) copolymers disclosed in Farah and Pietro, Polymer Bulletin 43, pp. 135-142 (1999), and the oxygen-crosslinked polysilanes disclosed in Hiraoka, et al., Polymers for Advanced Technologies 8, pp. 465-470 (1997).

Specific examples of crosslinkable transport layer materials for OLED devices that can be useful in transfer layers of the present invention include the silane functionalized triarylamine, the poly(norbornenes) with pendant triarylamine as disclosed in Bellmann, et al., Chem. Mater. 10, pp. 1668-1678 (1998), bis-functionalized hole transporting triarylamine as disclosed in Bayeri, et al., Macromol. Rapid Commun. 20, pp. 224-228 (1999), the various crosslinked conductive polyanilines and other polymers as disclosed in U.S. Pat. No. 6,030,550, the crosslinkable polyarylpolyamines disclosed in International Publication WO 97/33193, and the crosslinkable triphenyl amine-containing polyether ketone as disclosed in Japanese Unexamined Patent Publication Hei 9-255774.

Light emitting, charge transport, or charge injection materials used in transfer layers of the present invention may also have dopants incorporated therein either prior to or after thermal transfer. Dopants may be incorporated in materials for OLEDs to alter or enhance light emission properties, charge transport properties and/or other such properties.

Thermal transfer of materials from donor elements to receiver elements for emissive display and device applications is disclosed in U.S. Pat. Nos. 5,998,085 and 6,114,088, and in PCT Publication WO 00/41893.

The transfer layer can optionally include various additives. Suitable additives can include IR absorbers, dispersing agents, surfactants, stabilizers, plasticizers, crosslinking agents and coating aids. The transfer layer may also contain a variety of additives including but not limited to dyes, plasticizers, UV stabilizers, film forming additives, and adhesives.

It is typical but not required for a transfer layer with a binder that the polymer of the binder does not self-oxidize, decompose or degrade at the temperature achieved during the heat exposure so that the exposed areas of the transfer layer, are undamaged. Examples of suitable binders include styrene polymers and copolymers, including copolymers of styrene and (meth)acrylate esters and acids, such as styrene/methyl-methacrylate and styrene/methyl-methacrylate/acrylic-acid, copolymers of styrene and olefin monomers, such as styrene/ethylene/butylene, and copolymers of styrene and acrylonitrile; fluoropolymers; polymers and copolymers of (meth)acrylic acid and the corresponding esters, including those with ethylene and carbon monoxide; potycarbonates; polysulfones; polyurethanes; polyethers; and polyesters. The monomers for the above polymers can be substituted or unsubstituted. Mixtures of polymers can also be used. Other suitable binders include vinyl chloride polymers, vinyl acetate polymers, vinyl chloride-vinyl acetate copolymers, vinyl acetate-crotonic acid copolymers, styrene maleic anhydride half ester resins, (meth)acrylate polymers and copolymers, poly(vinyl acetals), poly(vinyl acetals) modified with anhydrides and amines, hydroxy alkyl cellulose resins and styrene acrylic resins.

FIG. 1 illustrates a donor element embodiment 100 having a copolymer based on styrene and maleic anhydride incorporated into the light-to-heat conversion layer 120.

The fundamental mechanism of the improved utility of using a copolymer based on styrene and maleic anhydride is not conclusively determined, but one may speculate without limiting or restricting the invention that a such a copolymer maintains the water content or the small molecule content of a layer of the donor element within certain appropriate levels over a relatively wide range of ambient humidity in the processing environment. The appropriate levels of internal water content can be speculated to favorably affect some property such as interlayer adhesion or thermal conductivity during the imaging process.

Another speculated mechanism of the improved utility of using a copolymer based on styrene and maleic anhydride in the light-to-heat conversion layer, that is advanced without the intention of limiting or restricting the invention, is that the copolymer acts to lower one of cohesive energy or adhesive energy or heat flow within or between layers, so that transfer of materials happens at lower amounts of light absorbance or similarly over a wider range of light absorbance or at a different location than in the absence of the copolymer based on styrene and maleic anhydride.

One or more other conventional thermal transfer donor element layers can be included in the donor element of the instant invention, including but not limited to an interlayer, release layer, ejection layer, and thermal insulating layer.

A donor element of the present invention can be utilized for thermal transfer imaging onto a receiver element in a imagable assemblage. After transfer, either or both of the spent donor element (a negative of the image) and the imaged receiver element (a positive of the image) may be useful as a functional object.

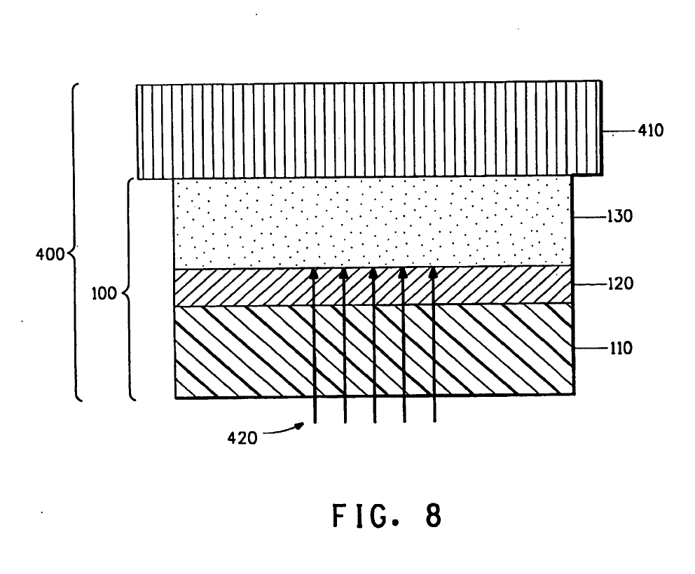

FIG. 8 shows an embodiment of an imagable assemblage 400 with the transfer layer 130 of the donor element 100 in contact with a receiver element 410. Light 420 can impinge on the support layer 110 and the light-to-heat conversion layer 120 and can be absorbed by the light-to-heat conversion layer 120. When sufficient light is absorbed and produces the appropriate heating, the selected portion of the transfer layer 130 adjacent the appropriately heated light-to-heat conversion layer will transfer to the receiver element.

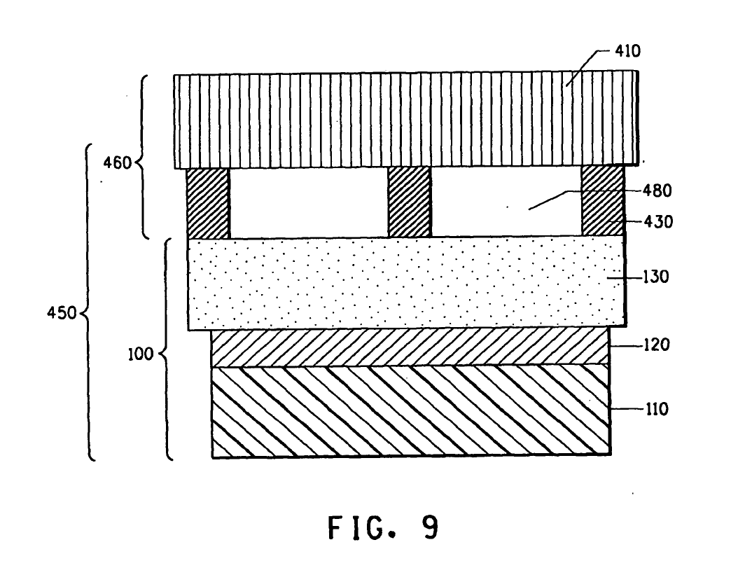

FIG. 9 shows an embodiment of an imagable assemblage 450 with the transfer layer 130 of the donor element 100 in intermittent contact with the receiver element 460 along the surface of previously transferred material 430 placed upon receiver base layer 410. The receiver layer 410, can be separated by a short distance from the transfer layer 130, for example by air 480.

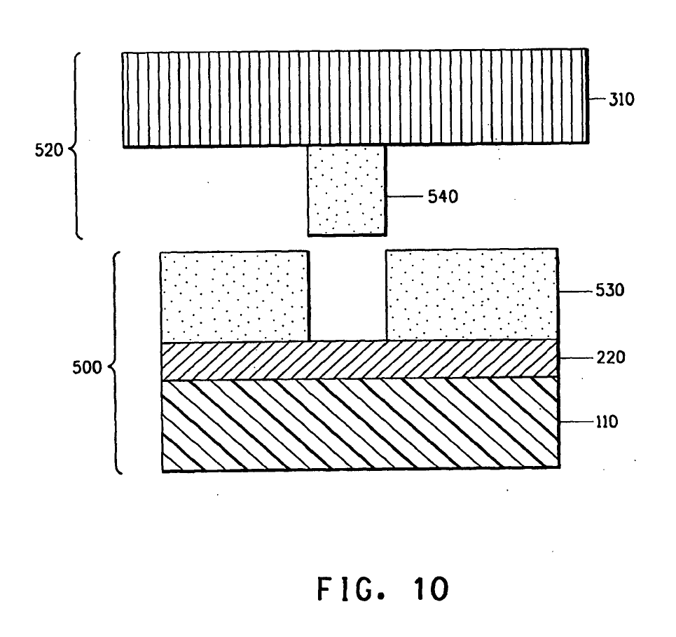

A textured receiver such as 460 can be obtained by a prior thermal transfer and separation step as shown in FIG. 10. In imagable assemblage 450, the donor element is in contact with the receiver element 460. The contact is intermittent rather than continuous. The layers of the donor element are adjacent the layer 410, though not in contact with the layer 410—the term adjacent not requiring contact.

FIG. 10 shows for one embodiment the products of separation of the assemblage 400 after image-wise exposure to sufficient light, for the case where the entire volume of the transfer layer is transferred (mass transfer) in sufficiently illuminated areas. After separation, the spent donor element 500 has the support layer 110 below the light-to-heat conversion layer 120, and retained portions 530 of the transfer layer. The imaged receiver element 520 has new transferred material 540 from the transfer layer in the areas corresponding to the illumination, upon the original receiver 410.

The Receiver Element

The receiver element may be any item suitable for a particular application including, but not limited to, glass, transparent films, reflective films, metals, semiconductors, various papers, and plastics. For example, receiver elements may be any type of substrate or display element suitable for display applications. Receiver elements suitable for use in displays such as liquid crystal displays or emissive displays include rigid or flexible substrates that are substantially transmissive to visible light. Examples of rigid receiver elements include glass, indium-tin oxide coated glass, low temperature polysilicon (LTPS), and rigid plastic. Suitable flexible substrates include substantially clear and transmissive polymer films, reflective films, non-birefringent films, transflective films, polarizing films, multilayer optical films, and the like. Suitable polymer substrates include polyester base (e.g., polyethylene terephthalate, polyethylene naphthalate), polycarbonate resins, polyolefin resins, polyvinyl resins (e.g., polyvinyl chloride, polyvinylidene chloride, polyvinyl acetals, etc.), cellulose ester bases (e.g., cellulose triacetate, cellulose acetate), and other conventional polymeric films used as supports in various imaging arts. Transparent polymeric film base of from about 2 to about 200 mils (i.e., 0.05 to 5 mm) is preferred.

For glass receiver elements, a typical thickness is about 0.2 to 2.0 mm. It is often desirable to use glass substrates that are about 1.0 mm thick or less, or even 0.7 mm thick or less. Thinner substrates result in thinner and lighter weight displays. Certain processing, handling, and assembling conditions, however, may suggest that thicker substrates be used. For example, some assembly conditions may require compression of the display assembly to fix the positions of spacers disposed between the substrates. The competing concerns of thin substrates for lighter displays and thick substrates for reliable handling and processing can be balanced to achieve a preferred construction for particular display dimensions.

If the receiver element is a polymeric film, it may be preferred that the film be non-birefringent to substantially prevent interference with the operation of the display in which it is to be integrated, or it may be preferred that the film be birefringent to achieve desired optical effects. Exemplary non-birefringent receiver elements are polyesters that are solvent cast. Typical examples of these are those derived from polymers consisting or consisting essentially of repeating, interpolymerized units derived from 9,9-bis-(4-hydroxyphenyl)-fluorine and isophthalic acid, terephthalic acid or mixtures thereof, the polymer being sufficiently low in oligomer (i.e., chemical species having molecular weights of about 8000 or less) content to allow formation of a uniform film. This polymer has been disclosed as one component in a thermal transfer receiving element in U.S. Pat. No. 5,318,938, herein incorporated by reference. Another class of non-birefringent substrates are amorphous polyolefins (e.g., those sold under the trade designation Zeonex™. from Nippon Zeon Co., Ltd.). Exemplary birefringent polymeric receiver elements include multilayer polarizers or mirrors such as those disclosed in U.S. Pat. Nos. 5,882,774 and 5,828,488, and in International Publication No. WO 95/17303, herein incorporated by reference.

The donor element is placed adjacent a receiver element in a fixed spatial relationship, comprising in order, the support layer, the light-to-heat conversion layer, the transfer layer, and the receiver element. The imagable assemblage is image-wise exposed to imaging light, causing local movement of material from the transfer layer of the donor element towards the receiver element. After imaging, the assemblage is termed an imaged assemblage. The imaged donor element (also called the spent donor element) and the imaged receiver element of the imaged assemblage are then separated.

The donor element of the present invention can be made by a variety of methods. In one embodiment, a light-to-heat conversion layer coating composition or its precursor diluted coating composition can be coated on to a support layer and optionally concentrated. The coating composition may be applied to the support layer by any suitable conventional coating technique such as gravure roll coating, reverse roll coating, dip coating, bead coating, slot coating or electrostatic spray coating.

Prior to deposition of the coating composition onto the support layer, the exposed surface thereof may, if desired, be subjected to a chemical or physical surface-modifying treatment to improve the bond between that surface and the subsequently applied coating composition. One embodiment is to subject the exposed surface of the support layer to a high voltage electrical stress accompanied by a corona discharge. Alternatively, the support layer may be pretreated with an agent known in the art to have a solvent or swelling action on the support layer polymer. Examples of such agents, which are particularly suitable for the treatment of a polyester support layer, include a halogenated phenol dissolved in a common organic solvent e.g. a solution of p-chloro-m-cresol, 2,4-dichlorophenol, 2,4,5- or 2,4,6-trichlorophenol or 4-chlororesorcinol in acetone or methanol. A treatment by corona discharge may be effected in air at atmospheric pressure with conventional equipment using a high frequency, high voltage generator, preferably having a power output of from about 1 to about 20 kW at a potential of from about 1 to about 100 kV. Discharge is conventionally accomplished by passing the film over a dielectric support roller at the discharge station at a linear speed preferably of 0.01 to 10 m/s. The discharge electrodes may be positioned from about 0.1 to about 10.0 mm from the moving film surface.

Vacuum and/or pressure can be used to hold the donor and receiver elements together in the imagable assemblage. As one alternative, the thermally imagable donor and receiver elements can be held together by fusion of layers at the periphery. As another alternative, the thermally imagable donor and receiver elements can be taped together and taped to the imaging apparatus, or a pin/clamping system can be used. As yet another alternative, the thermally imagable donor element can be laminated to the receiver element to afford a laserable assemblage. A laserable assemblage can be conveniently mounted on a drum to facilitate laser imaging, or on a flat, moveable stage. Those skilled in the art will recognize that other engine architectures such as flatbed, internal drum, capstan drive, etc., can also be used with this invention.

The light-to-heat conversion layer 120 of FIG. 9 acts during imaging to localize a substantial proportion of heat generation into an appropriate region of the donor element, by absorbing the impinging light, so as to cause the transfer of at least some component of the transfer layer to a receiver element. In the present invention, the presence of copolymer based on styrene and maleic anhydride in the light-to-heat conversion layer facilitates mass transfer of the components to be transferred from the transfer layer onto the receiver element. It is believed that the incident light helps release water and/or other small molecule such as methanol, depending upon the pendent group on the copolymer corresponding to the monomeric repeat unit of maleic anhydride. The small molecule facilitates the transfer of the components of the transfer layer that one desires to transfer to the receiver element. The mechanism of transfer, i.e., that a small molecules facilitate the transfer is only one possibility. There may be other transfer mechanisms that may be playing a role. This patent specification does not intend to describe or limit the transfer to one through such a small molecule. Such a mechanism is speculatively proposed only for the purpose of illustration and is not intended to limit the scope of the invention to the transfer mechanism.

Various other mechanisms of transfer can occur, such as but not limited to sublimation transfer, diffusion transfer, mass transfer, ablative mass transfer, melt transfer, etc. In an embodiment operating by thermal mass transfer, transfer of a full, or partial, intact volume (a mass) of the transfer layer occurs at an area where light impinges, without substantial segregation of the components of the volume. Transfer of at least one component of a volume of a mixture, but not an intact volume including substantially all components, can occur in other cases such as sublimation transfer and diffusion transfer, where a matrix material holding the transferable material is substantially untransferred.

A variety of light-emitting sources can be used to heat the thermal transfer donor elements. For analog techniques (e.g., exposure through a mask), high-powered light sources (e.g., xenon flash lamps and lasers) are useful. For digital imaging techniques, infrared, visible, and ultraviolet lasers are particularly useful.

As used herein, the term “light” is intended to cover radiation having a wavelength from about 200 nm to about 300 μm. This light spectrum can be divided into a ultraviolet (UV) range of about 200 nm to about 400 nm, the visible range of about 400 to about 750 nm, and the infrared (IR) range of about 750 nm to about 300 μm. The near infrared spectrum includes from about 750 to about 2,500 nm, the mid infrared spectrum from about 2,500 to about 12,500 nm, and the far infrared spectrum from about 12,500 nm to about 300 μm (300,000 nm or 0.3 mm). The short wavelength near infrared spectrum includes the wavelengths from about 750 nm to about 1200 nm, the long wavelength near infrared spectrum includes the wavelengths from about 1,200 nm to about 2,500 nm.

In one embodiment, the exposure step is accomplished with an imaging laser at a laser fluence of about 600 mJ/cm² or less, most typically about 250 to about 440 mJ/cm². Other light sources and irradiation conditions can be suitable based on, among other things, the donor element construction, the transfer layer material, the mode of thermal transfer, and other such factors.

When high spot placement accuracy is required (e.g., for high information full color display applications) over large substrate areas, a laser is particularly useful as the light source. Laser sources are also compatible with both large rigid substrates (e.g., 1 meter by 1 meter by 1.1 mm and larger substrates such as color filter glass) and continuous or sheeted film substrates (e.g., 100 μm thickness polyimide sheets).

Particularly advantageous are diode lasers, for example those emitting in the region of about 750 to about 870 nm and up to 1200 nm which offer a substantial advantage in terms of their small size, low cost, stability, reliability, ruggedness and ease of modulation. Such lasers are available from, for example, Spectra Diode Laboratories (San Jose, Calif.). One device used for applying an image to the image receiving layer is the Creo Spectrum Trendsetter 3244F, which utilizes lasers emitting near 830 nm. This device utilizes a Spatial Light Modulator to split and modulate the 5-50 Watt output from the ˜830 nm laser diode array. Associated optics focus this light onto the imagable elements. This produces 0.1 to 30 Watts of imaging light on the donor element, focused to an array of 50 to 240 individual beams, each with 10-200 mW of light in approximately 10×10 to 2×10 micron spots. Similar exposure can be obtained with individual lasers per spot, such as disclosed in U.S. Pat. No. 4,743,091. In this case each laser emits 50-300 mW of electrically modulated light at 780-870 nm. Other options include fiber coupled lasers emitting 500-3000 mW and each individually modulated and focused on the media. Such a laser can be obtained from Opto Power in Tucson, Ariz.

Suitable lasers for thermal imaging include, for example, high power (>90 mW) single mode laser diodes, fiber-coupled laser diodes, and diode-pumped solid state lasers (e.g., Nd:YAG and Nd:YLF). Laser exposure dwell times can vary widely from, for example, a few hundredths of microseconds to tens of microseconds or more, and laser fluences can be in the range from, for example, about 0.01 to about 5 J/cm² or more.

In one embodiment the imaging light is provided by one or more lasers emitting intensely at a wavelength between 650 and 1300 nm, for example a selection of the ranges of 660 to 900 nm, and 950 to 1200 nm.

In one embodiment, during imaging, substantially (greater than 80%) the entire transfer layer of the donor element in the selectively illuminated regions is transferred to the receiver element without transferring significant portions or components of the other layers of the thermal mass transfer donor element, such as an optional interlayer or a light-to-heat conversion layer. This is desirable, especially when the light-to-heat conversion layer has different properties than the transferred material and can interfere with the functionality obtained by the transfer. For example, a yellow colored or black light-to-heat conversion layer transferring with a transparent blue transfer layer for a blue color filter window, or an electrically insulating light-to-heat conversion layer transferring onto a conducting pad with a conductive transfer layer, can be unacceptable.

In another embodiment, the transfer layer is a mixture of components, and transfer by illumination of the donor element only occurs for selected components such as sublimable dyes, or melted components.

The mode of thermal transfer can vary depending on the type of irradiation, the type of materials in the transfer layer, etc., and generally occurs via one or more mechanisms, one or more of which may be emphasized or de-emphasized during transfer depending on imaging conditions, donor constructions, and so forth. The following modes of thermal transfer are not limiting to the invention, and are given for illustrative purposes only.

One speculated mechanism of thermal transfer includes thermal melt-stick transferwhereby localized heating at the interface between the transfer layer and the rest of the donor element can lower the adhesion of the thermal transfer layer to the donor in selected locations. Selected portions of the thermal transfer layer can adhere to the receiver element more strongly than to the donor so that when the donor element is removed, the selected portions of the transfer layer remain on the receptor. Another speculated mechanism of thermal transfer includes ablative transfer whereby localized heating can be used to ablate portions of the transfer layer off of the donor element, thereby directing ablated material toward the receptor. Yet another speculated mechanism of thermal transfer includes sublimation whereby material dispersed in the transfer layer can be sublimated by heat generated in the donor element. A portion of the sublimated material can condense on the receptor.

During imaging, the thermal transfer donor element can be brought into intimate contact with a receiver element (as might typically be the case for thermal melt-stick transfer mechanisms) or the thermal transfer donor element can be spaced some distance from the receiver element (as can be the case for ablative transfer mechanisms or transfer material sublimation mechanisms). In at least some instances, pressure or vacuum can be used to hold the thermal transfer donor element in intimate contact with the receptor. In some instances, a mask can be placed between the thermal transfer donor element and the receiver element. Such a mask can be removable or can remain on the receiver element after transfer. A light source can then be used to heat the light-to-heat conversion layer (and optionally other layer(s) containing any light absorber) in an image-wise fashion (e.g., digitally or by analog exposure through a mask) to perform image-wise transfer and/or patterning of the transfer layer from the thermal transfer donor element to the receiver element.

A later step for the assemblage after imaging by image-wise light exposure is separating the imaged donor element from the imaged receiver element (FIG. 11). Usually this is done by simply peeling the two elements apart. This generally requires very little peel force, and is accomplished by simply separating the donor support from the receiver element. This can be done using any conventional separation technique and can be manual or automatic.

Typically the intended product is the receiver element, after light exposure and separation, onto which the transferred material has been transferred in a pattern. However, it is also possible for the intended product to be the donor element after light exposure and separation. In one embodiment where the donor support layer and the light-to-heat conversion layer are transparent and the transfer layer is opaque, the imaged donor element can be used as a photo-tool for conventional analog exposure of photosensitive materials, e.g., photo-resists, photopolymer printing plates, photosensitive proofing materials, medical hard copies, and the like. For photo-tool applications, it is important to maximize the density difference between “clear”, i.e., laser exposed and “opaque”, i.e., unexposed areas of the donor element. Thus the materials used in the donor element must be tailored to fit this application.

In one embodiment, the imaged receiver element can be used as a receiver element of a subsequent imagable assemblage with a donor element.

In one embodiment, using a donor element having layers of varying composition is useful in combination with a receiver element in an imagable assemblage for image-wise transfer of material from the donor element to the receiver element by the result of heat generated by a rapidly scanned, blinking laser beam shining an intense laser beam on areas intended for material transfer. Separation of spent donor element from imaged receiver element provides articles useful for color filters, visual displays, color image reproduction, circuitry, etc.

In one embodiment, a donor element construction of at least three layers comprising a support layer, a layer useful for light-to-heat conversion (LTHC layer) such as a metallic, pigmented, or dye-containing layer, and a transfer layer is supplemented by additional layers in the construction that can be placed between or outside the three layers to modify properties such as interlayer adhesion, light absorption, heat transfer, handling, etc.

Typically, selected portions of the transfer layer are transferred to the receiver element without transferring significant portions of the other layers of the thermal transfer donor element, such as an optional interlayer or the light-to-heat conversion layer. The presence of the optional interlayer may eliminate or reduce the transfer of material from the light-to-heat conversion layer to the receiver element and/or reduce distortion in the transferred portion of the transfer layer. Preferably, under imaging conditions, the adhesion of the optional interlayer to the light-to-heat conversion layer is greater than the adhesion of the interlayer to the transfer layer. In some instances, a reflective interlayer can be used to attenuate the level of imaging light transmitted through the interlayer and reduce any damage to the transferred portion of the transfer layer that may result from interaction of the transmitted light with the transfer layer and/or the receptor. This is particularly beneficial in reducing thermal damage, which may occur when the receiver element is highly absorptive of the imaging light.

During laser exposure, it may be desirable to minimize formation of interference patterns due to multiple reflections from the imaged material. This can be accomplished by various methods. The most common method is to effectively roughen the surface of the thermal transfer donor element on the scale of the incident light as described in U.S. Pat. No. 5,089,372. This has the effect of disrupting the spatial coherence of the incident light, thus minimizing self interference. An alternate method is to employ an antireflection coating within the thermal transfer donor element. The use of anti-reflection coatings is known, and may consist of quarter-wave thicknesses of a coating such as magnesium fluoride, as described in U.S. Pat. No. 5,171,650.

Large thermal transfer donor elements can be used, including thermal transfer donor elements that have length and width dimensions of a meter or more. In operation, a laser can be rastered or otherwise moved across the large thermal transfer donor element, the laser being selectively operated to illuminate portions of the thermal transfer donor element according to a desired pattern. Alternatively, the laser may be stationary and the thermal transfer donor element and receiver element substrate moved beneath the laser.

In some instances, it may be necessary, desirable, and/or convenient to sequentially use two or more different thermal transfer donor elements to form a device, such as an optical display.

For example, a black matrix-defining pixel windows may be formed on a glass plate by thermal transfer imaging, followed by the sequential thermal transfer of multiple colors into separate windows, forming color filter elements in the windows of the black matrix. As another example, a black matrix may be formed, followed by the thermal transfer of one or more layers of a thin film transistor using for switching transparency in a liquid crystal display. As another example, multiple-layer devices can be formed by transferring separate layers or separate stacks of layers from different thermal transfer donor elements. Multilayer stacks can also be transferred as a single transfer unit from a single donor element. Examples of multilayer devices include transistors such as organic field effect transistors (OFETs), organic electroluminescent pixels and/or devices, including organic light emitting diodes (OLEDs). Multiple donor sheets can also be used to form separate components in the same layer on the receptor. For example, three different color donors can be used to form color fitters for a color electronic display. Also, separate donor sheets, each having multiple layer transfer layers, can be used to pattern different multilayer devices (e.g., OLEDs that emit different colors, OLEDs and OFETs that connect to form addressable pixels, etc.). A variety of other combinations of two or more thermal transfer donor elements can be used to form a device, each thermal transfer donor element forming one or more portions of the device. It will be understood other portions of these devices, or other devices on the receptor, may be formed in whole or in part by any suitable process including photolithographic processes, ink-jet processes, and various other printing or mask-based processes.

### EXPERIMENTAL

### Examples

### Example 1

### Comparison of Donor Elements with SMA 1440H and Control Polymer Amertech 1200 Polyester Clear

The following example provides a comparative example of a control donor element having a light-to-heat conversion layer comprising a water dispersible sulphonated polyester binder and a dye capable of absorbing near IR laser radiation. This control donor element was compared with a donor element having a light-to-heat conversion layer comprising the polymer SMA 1440H.

More specifically, for a comparative example 1, one hundred parts by weight of a light-to-heat conversion layer coating composition was made by taking about 79.80 parts of de-ionized water, 1.00 part Hampford NIR Dye 822 (CAS162411-28-1, also known as 1H-Benz[e]indolium, 2-[2-[2-chloro-3-[[1,3-dihydro-1,1-dimethyl-3-(4-sulfobutyl)-2H-benz[e]indol-2-ylidene]ethylidene]-1-cyclohexen-1-yl]ethenyl]-1,1-dimethyl-3-(4-sulfobutyl)-, inner salt, from Hampford Research, Stratford, Conn.), 0.50 part of dimethylaminoethanol, 6.48 parts of aqueous dispersed 30 mass percent sulphonated polyester (AmerTech polyester sulphonate clear, having a glass transition temperature of 63° C. and a minimum film forming temperature of 27° C.), 0.25 part substrate wetting additive (Tego WET 250, 100% solids polyether modified trisiloxane copolymer from Degussa, Hopewell, Va.), 1.4 parts of P-DMAE-EP (potassium salt of DMAE and ethyl phosphate) (11.5% aqueous), 1.00 parts Cymel 350 (20%, Cytec Industries, West Patterson, N.J.), and 0.20 parts ammonium p-toluenesulphonate. These ingredients are listed in order of addition in the accompanying table.

Release-modifier P-DMAE-EP was made in aqueous solution at 11.5% solids by adding concentrated aqueous potassium hydroxide to aqueous ethyl acid phosphate (Stauffer Chemicals, Westport, Conn.) to achieve a pH of about 4.5, followed by adding dimethyaminoethanol to achieve a pH of about 7.5.

For the SMA1440H donor element, one hundred parts by weight of a light-to-heat conversion layer coating composition was made by taking about 89.20 parts of de-ionized water, 0.50 part of dimethylaminoethanol, 1.00 part Hampford NIR Dye 822 (from Hampford Research, Stratford, Conn.), 0.25 part substrate wetting additive (Tego WET 250, 100% solids polyether modified trisiloxane copolymer from Degussa, Hopewell, Va.), 1.4 parts of 11.5% aqueous P-DMAE-EP, 1.69 parts Cymel 350 (20%; Cytec Industries, West Patterson, N.J.), and 0.30 parts 10% aqueous ammonium p-toluenesulphonate. These ingredients are listed in order of addition in the accompanying table.

The following solutions were prepared by adding ingredients in the order listed into a beaker and then stirring the contents of the beaker at room temperature for about 2 hours, both for the control sample with AmerTech 1200 Polyester Clear polymer and the SMA 1440H.

TABLE 1

| | Comparative | |
|---|---|---|
| | Example 1 | |
| | AmerTech 1200 | Example 2 |
| | Polyester | SMA |
| Ingredient | Clear Control | 1440H |
| Deionized Water (g) | 894.00 | 800.00 |
| DiMethylAminoEthanol [100%] (g) | 5.00 | 5.00 |
| SDA 4927 (g) | 10.00 | 10.00 |
| (H.W. Sands Corporation. Jupiter, FL) | | |
| AmerTech Polyester Clear [30%] (g) | 65.00 | |
| (American Inks and Coatings Corp., | | |
| Valley Forge; PA) | | |
| Tego Wet 251 [100%] (g) | 2.50 | 2.50 |
| (Goldschmidt Chemical, Hopewell, VA) | | |
| P-DMAE-EP [11.5%] (g) | 14.00 | 14.00 |
| SMA1440H [34%] (g) | | 86.00 |
| (Sartomer Corp., Exton, PA) | | |
| Cymel 350 [20%] (g) | 10.00 | 17.00 |
| (Cytec Industries, West Paterson, NJ) | | |
| Ammonium | 2.00 | 3.00 |
| p-toluenesulphonate [10%] (g) | | |

For both samples, the well-mixed light-to-heat conversion layer coating composition was coated using a #0 wire-wound rod on to a 50 micron polyester support layer to give a wet coated thickness of about 3 microns and a dried coating thickness of about 190 nm and a transmission of 830 nm wavelength light of about 45%. The resulting support layer/light-to-heat conversion layer construction was coated on the light-to-heat conversion layer side with a conventional blue pigmented transfer layer with a dry thickness of 1 to 2 microns to provide a donor element identified in the accompanying table.

The solutions were coated on a PET casting line and then dried to produce coatings with the following % transmission at 830 nm wavelength:

TABLE 2

| | AmerTech 1200 Polyester Clear Control | SMA 1440H |
|---|---|---|
| % Transmission | 48 | 47 |

A red composition of the following formulation was prepared by adding the ingredients in the order listed into a beaker accompanied by stirring for about 3 hours.

TABLE 3

| | |
|---|---|
| Added water (g) | 245.146 |
| Carboset GA2300 (g) | 108.932 |
| (Noveon, Inc, Cleveland, OH) | |
| Carboset xpd2091 (g) | 7.865 |
| (Noveon, Inc, Cleveland, OH) | |
| NH₄OH (3%) (g) | 2.496 |
| Red 254 Pigment Dispersion (g) | 218.4 |
| (Penn Color, Inc. Doylestown, PA) | |
| Yellow 83 Pigment Dispersion (g) | 5.117 |
| (Penn Color, Inc. Doylestown, PA) | |
| Zonyl FSA (g) | 2.496 |
| (DuPont, Wilmington, DE) | |
| SDA 4927 (g) | 1.435 |
| (H.W. Sands Corporation, Jupiter, FL) | |
| Polyol TP70 (g) | 7.488 |
| Surfynol DF110D (g) | 0.624 |
| (Air Products and Chemicals, Allentown, PA) | |

The red formulation was then coated onto the NIR-sensitized coating and dried to a dried coating weight of 40.0 mg/dm². This forms a red donor element.

The glass substrate bears a matrix pattern, formed in a preliminary step, composed of black-pigmented resin which formed the pixel boundaries. Blue and green pixels were first transferred to the glass color filter substrate. A section of donor element was combined with a glass color filter substrate having red pixel elements in the order of support-layer/light-to-heat conversion layer/transfer layer/glass, to form an imagable assemblage. The imagable assemblage was imaged using a rapidly moving, blinking 830 nm infrared laser with seven separately sampled output energies for the control sample (nominally 14.0, 15.5, 17.0, 18.5, 20, 21.5, and 23.0 W) and eight separately sampled output energies for the SMA 1440H sample (nominally 12.5, 14.0, 15.5, 17.0, 18.5, 20, 21.5, and 23.0 W), and impinging on the support layer at a fluence of approximately 250-500 mJ/cm² and exposure time of less than 5 μs to transfer red pixels suitable for a color filter.

The imaged assemblage was separated into a spent red donor element and a glass color filter substrate having green, red and blue pixel elements. The imaged color filter baked at 230° C. for 1 hour to solidify the transferred color pixels. The baked filter was then examined with a microscope at 200× total magnifying power, and the width of the baked red lines measured at a range of incident laser powers. Next, the roughness of the transferred pixels was measured with a Tencor P-15 Stylus profilometer, and roughness values are reported as Rq (roughness quotient) in nm.

The spent donor element was analyzed colorimetrically for untransferred percentage of red transfer layer in areas intended for 100% transfer, which value was subtracted from 100% to give the achieved transfer percentage. The red pixel elements of the glass color filter substrate were analyzed colorimetrically for transferred line width (expressed as a percentage of intended imaged transfer width from the imaging laser use) and the color values of the transferred material (expressed in xyY coordinates of the CIE scale as a difference from the original donor element values). The thermal transfer process and the quality of the colors were assessed by measuring x, y and Y values for color coordinates in the CIE system in which x and y describe the hue of a color, and Y is a measure of the luminance (ratio of transmitted photons/incident photons). Color of the transferred pixels was measured using an Ocean Optics diode spectrophotometer

The following Table 4 records the performance of the donor elements by imaging using various nominal levels of laser energy. The first column labeled “Example” assigns an identifier to each example. The second column lists the energy used, the third column corresponds to whether the “x” value is within specification or not, the fourth column corresponds to whether the “y” value is within specification or not and the fifth column corresponds to whether the “Y” value is within specification or not.

Color Value of the two films is presented below.

TABLE 4

| Examples | Power W | x | y | Y |
|---|---|---|---|---|
| AmerTech 1200 | 23.0 | In Spec | In Spec | Close |
| Polyester Clear | 21.5 | In Spec | In Spec | Close |
| Control | 20.0 | In Spec | In Spec | In Spec |
| | 18.5 | In Spec | In Spec | In Spec |
| | 17.0 | In Spec | In Spec | In Spec |
| | 15.5 | Close | In Spec | In Spec |
| | 14.0 | Close | In Spec | In Spec |
| SMA 1440 H | 23.0 | In Spec | In Spec | Close |
| | 21.5 | In Spec | In Spec | In Spec |
| | 20.0 | In Spec | In Spec | In Spec |
| | 18.5 | In Spec | In Spec | In Spec |
| | 17.0 | In Spec | In Spec | In Spec |
| | 15.5 | In Spec | In Spec | In Spec |
| | 14.0 | In Spec | In Spec | In Spec |
| | 12.5 | In Spec | In Spec | In Spec |

Roughness quotient Rq was tabulated versus linewidth below in Table 5. An Rq less than 40 nm and linewidth greater than 85 microns are desired. The SMA 1440H Example met these values at lower applied power, and gave a wider range of operating power. This is desirable as laser power can drift in practice, and the SMA 1440H sample will deliver desired color, linewidth and Rq over a greater range of applied power.

TABLE 5

| Example | Power W | Linewidth microns | Rq nm |
|---|---|---|---|
| AmerTech 1200 | 23.0 | 101.4 | 37.4 |
| Polyester Clear | 21.5 | 102.1 | 59.33 |
| Control | 20.0 | 96.7 | 28.97 |
| | 18.5 | 100.1 | 14.37 |
| | 17.0 | 95 | 25.13 |
| SMA 1440 H | 23.0 | 105.5 | 88.53 |
| | 21.5 | 103.8 | 55.7 |
| | 20.0 | 101.4 | 37.1 |
| | 18.5 | 101.1 | 11.6 |
| | 17.0 | 86.8 | 11.53 |
| | 15.5 | 90.6 | 11.23 |
| | 14.0 | 88.6 | 10.78 |

### Example 2

### Comparison of Donor Elements with SMA Variants to Amertech 1200 Polyester Clear

The following resins were compared for their effects on imaging when used as a binder in an NIR-sensitized light-to-heat conversion layer.

TABLE 6

| Sample No. | Binder Resin | Acid No. | Tg | Mn/Mw |
|---|---|---|---|---|
| 2-228 | SMA 1440H | 185 | 60 | 2800/7000 |
| | partial ester w Bu(O)EtOH | | | |
| 3-229 | SMA1000H | 480 | 155 | 2800/5500 |
| | Styrene:MA 1:1 | | | |
| 4-230 | SMA2625H/AF | 220 | 110 | 3600/9000 |
| | partial ester with propanol | | | |
| 5-231 | SMA3000HNa | 285 | 125 | 3800/9500 |
| | Styrene:MA 3:1 | | | |
| 6-232 | PMA grade A hydrolyzed | | | |
| | [50%] | | | |
| 7-227 | AmerTech 1200 | | 63 | |
| Control | Polyester Clear | | | |

The following solutions were prepared by adding ingredients in the order listed into a beaker accompanied by stirring at room temperature for 2 hours.

TABLE 7

| Ingredients/Sample | 7-227 | | | | | |
|---|---|---|---|---|---|---|
| No. | Control | 2-228 | 3-229 | 4-230 | 5-231 | 6-232 |
| Deionized Water | 45.2 | 18.4 | 46.7 | 8.0 | 5.7 | 59.2 |
| DMAE [100%] | 1.0 | 1.0 | 1.0 | 1.0 | 1.0 | 1.0 |
| Hampford dye 822 | 1.9 | 1.9 | 1.9 | 1.9 | 1.9 | 1.9 |
| [100%] | | | | | | |
| AmerTech Polyester | 35.0 | | | | | |
| Clear [30%] | | | | | | |
| SMA1440H [17%] | | 61.8 | | | | |
| SMA1000H [31%] | | | 33.5 | | | |
| SMA2825H/AF | | | | 72.2 | | |
| [14.5%] | | | | | | |
| SMA3000HNa [14%] | | | | | 74.5 | |
| PMA Grade A | | | | | | 21.0 |
| hydrolyzed [50%] | | | | | | |
| Tego Wet 251 [100%] | 1.0 | 1.0 | 1.0 | 1.0 | 1.0 | 1.0 |
| P-DMAE-EP [11.5%] | 1.4 | 1.4 | 1.4 | 1.4 | 1.4 | 1.4 |
| Cymel 350 [20%] | 7.5 | 7.5 | 7.5 | 7.5 | 7.5 | 7.5 |
| ammonium p- | 3.0 | 3.0 | 3.0 | 3.0 | 3.0 | 3.0 |
| toluenesulphonate | | | | | | |
| [10%] | | | | | | |
| Isopropanol | 4.0 | 4.0 | 4.0 | 4.0 | 4.0 | 4.0 |

Coatings had the following characteristics.

TABLE 8

| | | | % Transmission |
|---|---|---|---|
| Film | Binder Resin | Coating Quality | at 830 nm |
| 2-228 | SMA 1440H | Lightly reticulated | 28.9 |
| | partial ester | | |
| | w Bu(O)EtOH | | |
| 3-229 | SMA1000H | Highly streaked | 59.7 |
| | Styrene:MA 1:1 | | |
| 4-230 | SMA2625H/AF | Highly reticulated | 38.3 |
| | partial ester | | |
| | with propanol | | |
| 5-231 | SMA3000HNa | Highly streaked | 70.6 |
| | Styrene:MA 3:1 | | |
| 6-232 | PMA grade A | Unacceptably tacky | 51.4 |
| | hydrolyzed [50%] | | |
| 7-227 | AmerTech 1200 | Light streaks | 44.5 |
| Control | Polyester Clear | | |
| | Control | | |

A red composition of the following formulation was prepared by adding the ingredients in the order listed into a beaker accompanied by stirring for 3 hours.

TABLE 9

| | |
|---|---|
| Added water | 245.146 |
| Carboset GA2300 | 108.932 |
| Carboset xpd2091 | 7.865 |
| NH4OH (3%) | 2.496 |
| 32R345D R254 | 218.4 |
| 32Y145D Y83 | 5.117 |
| Zonyl FSA | 2.496 |
| SDA | 1.435 |
| Polyol TP70 (7EOTMP) | 7.488 |
| Surfynol DF110D | 0.624 |

The red formulation was coated onto the NIR-sensitized coating and dried with a dried coating weight of 40.0 mg/dm². This formed a red donor element.

The glass substrate bears a matrix pattern formed in a preliminary step composed of black-pigmented resin which forms pixel boundaries. Blue and green pixels were first transferred to the glass color filter substrate. A section of the red donor element was then combined with a glass color filter, forming an imagable assemblage. The imagable assemblage was imaged using a rapidly moving 830 nm laser impinging on the support layer in an exposure energy series ranging from 290 mJ/cm² to 380 mJ/cm².

TABLE 10

| Power | Platen | | Energy |
|---|---|---|---|
| Watts | mps | Watt/mps | mJ/cm² |
| 23 | 1.55 | 14.84 | 292.03 |
| 23 | 1.5 | 15.33 | 301.76 |
| 23 | 1.45 | 15.86 | 312.17 |
| 23 | 1.4 | 16.43 | 323.31 |
| 23 | 1.35 | 17.04 | 335.29 |
| 23 | 1.3 | 17.69 | 348.18 |
| 23 | 1.25 | 18.40 | 362.11 |
| 23 | 1.2 | 19.17 | 377.20 |

The red donor element was then removed, and the imaged color filter was baked at 230° C. for 1 hour to solidify the transferred color pixels.

The color of the transferred red pixels was measured using an Ocean Optics diode spectrophotometer and results are shown below for each of the donor elements in the set.

TABLE 11

| Example | Exposure | | | |
|---|---|---|---|---|
| No. | mJ/cm² | x | y | Y |
| 7-227 | 292 | In Spec | In Spec | In Spec |
| | 302 | In Spec | In Spec | In Spec |
| | 312 | In Spec | In Spec | In Spec |
| | 323 | In Spec | In Spec | In Spec |
| | 335 | In Spec | In Spec | In Spec |
| | 348 | Close | In Spec | In Spec |
| | 362 | In Spec | In Spec | In Spec |
| | 377 | | In Spec | Close |
| 2-228 | 292 | In Spec | In Spec | In Spec |
| | 302 | In Spec | In Spec | In Spec |
| | 312 | In Spec | In Spec | In Spec |
| | 323 | In Spec | In Spec | In Spec |
| | 335 | In Spec | In Spec | In Spec |
| | 348 | In Spec | In Spec | In Spec |
| | 362 | In Spec | In Spec | In Spec |
| | 377 | | Close | Close |
| 3-229 | 292 | Close | In Spec | In Spec |
| | 302 | | In Spec | In Spec |
| | 312 | | In Spec | In Spec |
| | 323 | | In Spec | In Spec |
| | 335 | | In Spec | Close |
| | 348 | | In Spec | Close |
| | 362 | | Close | |
| | 377 | | Close | Close |
| 4-230 | 292 | | In Spec | In Spec |
| | 302 | Close | In Spec | In Spec |
| | 312 | Close | In Spec | In Spec |
| | 323 | | In Spec | In Spec |
| | 335 | | In Spec | |
| | 348 | | In Spec | In Spec |
| | 362 | | Close | Close |
| | 377 | | Close | In Spec |
| 5-231 | 292 | | In Spec | In Spec |
| | 302 | | In Spec | In Spec |
| | 312 | | In Spec | In Spec |
| | 323 | | In Spec | In Spec |
| | 335 | | In Spec | In Spec |
| | 348 | | In Spec | Close |
| | 362 | | In Spec | Close |
| | 377 | | In Spec | Close |

* Sample 6-232 was unacceptably tacky and could not be imaged.

Color rendition was intact from 292 to 362 mJ exposure with sample 228, with sample 227 being the next-best. All other films were found to be out of specification in their values of x, largely due to irregular coating quality of the light-to-heat conversion layer.

The annealed filter was then examined with a microscope at 200× total magnifying power, and the transferred pixels were inspected at a range of incident exposure energies. When the red pixel filled the entire matrix element, a criterion known as “trapped” was fulfilled. If the red pixel did not fill the matrix fully, this unsatisfactory condition is referred to as “poor trapping”. As energy was increased above the optimum value for a given film, transferred pixels were rough, and at high levels of overexposure, showed pinholes. These data are summarized in Table 12 for the different samples.

Sample 228 provided the best results, trapping well at low energy, with color values within prescribed specification, and coating quality good enough to form uniform transferred pixels.

TABLE 12

| | 377 | 362 | 348 | 335 | 323 | 312 | 302 | 292 | Acid |
|---|---|---|---|---|---|---|---|---|---|
| Samples | mJ/cm² | mJ/cm² | mJ/cm² | mJ/cm² | mJ/cm² | mJ/cm² | mJ/cm² | mJ/cm² | No. |
| 227 | Trapped, | Trapped, | Trapped, | Trapped, | Slight non- | Slight non- | poor | poor | |
| | Rough | Rough | good lines | good lines | trapping | trapping | trapping | trapping | |
| 228 | Trapped, | Trapped, | Trapped, | Trapped, | Trapped, | Trapped, | Trapped, | Trapped, | 185 |
| | Rough | Rough | Rough | Rough | Rough | Rough | good lines | good lines | |
| 229 | Pinholes, | Pinholes, | Pinholes, | Pinholes, | Pinholes, | Pinholes, | Pinholes, | Pinholes, | 480 |
| | over- | over- | over- | over- | over | over- | over- | over- | |
| | exposed | exposed | exposed | exposed | exposed | exposed | exposed | exposed | |
| 230 | Pinholes, | Pinholes, | Trapped, | Trapped, | Trapped, | Trapped, | Trapped, | Trapped, | 220 |
| | over- | over- | Rough | Rough | Rough | Rough | good lines | good lines | |
| | exposed | exposed | | | | | | | |
| 231 | Pinholes, | Pinholes, | Pinholes, | Pinholes, | Pinholes, | Pinholes, | OK, but | OK, but | 285 |
| | over- | over- | over- | over- | over- | over- | coating | coating | |
| | exposed | exposed | exposed | exposed | exposed | exposed | irregularities | irregularities | |
| | | | | | | | imaged | imaged | |

What is claimed is:

1. A donor element for light-induced transfer, comprising:
(a) a support layer;
(b) a light-to-heat conversion layer disposed adjacent one side of said support layer, wherein said light-to-heat conversion layer comprises a light absorber;
and
(c) a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer.

2. The donor element as recited in claim 1,
wherein said maleic anhydride-based polymer comprises a polymer selected from the group consisting of:
(i) maleic anhydride homopolymer;
(ii) maleic acid homopolymer;
(iii) fumaric acid homopolymer;
(iv) homopolymer of monoester of maleic acid;
(v) homopolymer of monoester of fumaric acid;
(vi) maleic anhydride copolymers;
(vii) maleic acid copolymers;
(viii) fumaric acid copolymers;
(ix) copolymers of monoester of maleic acid;
(x) copolymers of monoester of fumaric acid;
(xi) chemical combinations thereof;
(xii) physical mixtures thereof; and
(xiii) combinations thereof.;
wherein said maleic anhydride repeat unit is selected from at least one of the three configurations represented in 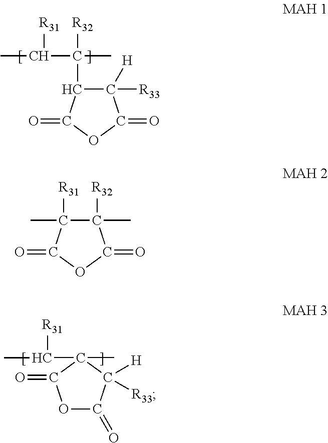
wherein said maleic acid repeat unit is selected from at least one of the three configurations represented in 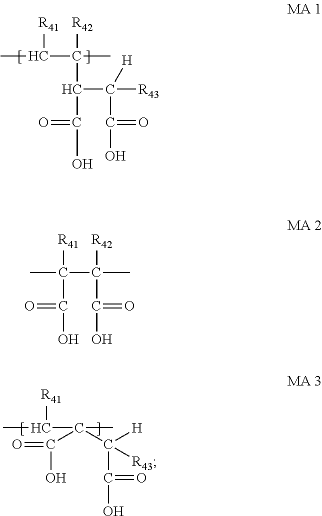
wherein said fumaric acid repeat unit is selected from at least one of the three configurations represented in 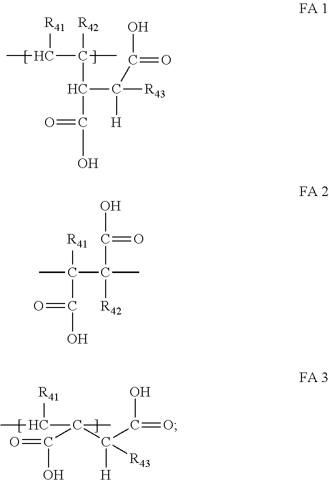
wherein said repeat unit of monoester of maleic acid is selected from at least one of the three configurations represented in 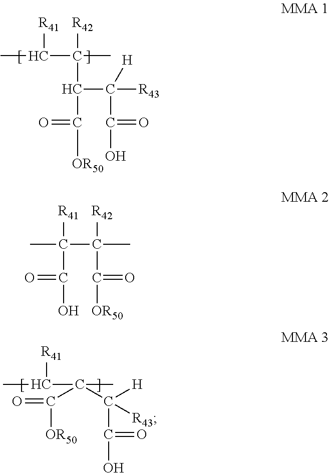
and wherein said repeat unit of monoester of fumaric acid is selected from at least one of the three configurations represented in 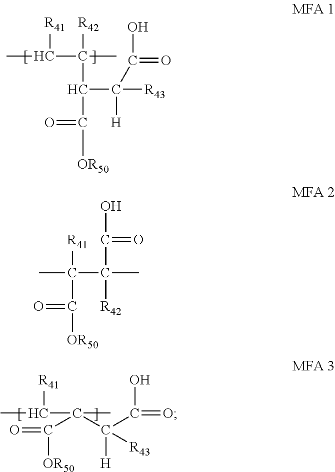
wherein, R₃₁, R₃₂, R₃₃, R₄₁, R₄₂. R₄₃ are the same or different groups, which can be hydrogen or alkyl of one to about five carbon atoms;
and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺; and
(g) combinations thereof.

3. The donor element as recited in claim 2, wherein said maleic anhydride-based polymer further comprises at least one type of repeat unit equivalent to that provided by the addition polymerization of at least one ethylenically unsaturated monomer.

4. The donor element as recited in claim 3, wherein said at least one ethylenically unsaturated monomer is selected from the group consisting of vinyl alkyl ethers, styrenes, vinyl acetate, ethylene, propylene, 1,3-butadiene, isobutylene, derivatives thereof and combinations thereof, wherein said alkyl said vinyl alkyl ether is from 1 to 10 carbon atoms.

5. The donor element as recited in claim 4, wherein said maleic anhydride-based polymer is a styrene-maleic anhydride polymer.

6. The donor element as recited in claim 5, wherein said maleic anhydride based polymer comprises a repeat unit equivalent to that provided by addition polymerization of monomers selected from the group consisting of an alkyl monoester of maleic acid, an alkyl monoester of fumaric acid, and combination thereof, wherein said alkyl monoester comprising 1 to 10 carbon atoms.

7. The donor element as recited in claim 6, wherein said maleic anhydride-based polymer further comprises a repeat unit equivalent to that provided by addition polymerization of maleic anhydride.

8. The donor element as recited in claim 7, wherein said maleic anhydride based polymer comprises the structure represented in Formula I: 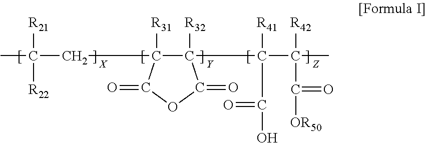
wherein x and z are any positive integer;
wherein y is zero or any positive integer;
R₂₁ and R₂₂ can be the same or different, and individually are hydrogen, alkyl, aryl, aralkyl, cycloalkyl, and halogen, provided that one of R₂₁ and R₂₂ is an aromatic group;
R₃₁, R₃₂, R₄₁ and R₄₂ are the same or different groups, which can be hydrogen or alkyl of one to about five carbon atoms; and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺; and
(g) combinations thereof.

9. The donor element as recited in claim 8, wherein R₂₁ and R₂₂, individually are hydrogen, methyl, phenyl, benzyl, or cycloalkyl of four to six carbon atoms.

10. The donor element as recited in claim 9, wherein R₂₁ R₃₁, R₃₂, R₃₃, R₄₁, R₄₂, R₄₃ are individually hydrogen, R₂₂ is phenyl, and R₅₀ is n-butoxyethylene (nCH₃—CH₂—CH₂—CH₂—O—CH₂—CH₂—).

11. The donor element as recited in claim 1, wherein said light absorber comprises a pigment.

12. The donor element as recited in claim 1, wherein said light absorber comprises at least one of carbon black and graphite.

13. The donor element as recited in claim 1, wherein said light absorber comprises a near-infrared dye.

14. The donor element as recited in claim 1, wherein said light absorber is characterized by having at least one local absorption maximum in the between the wavelengths of from about 750 nm and about 1200 nm.

15. The donor element as recited in claim 1, wherein said light-to-heat conversion layer is characterized by an absorbance maximum between the wavelengths of from about 650 and about 1200 nm that is at least three times larger in magnitude than said light-to-heat conversion layer absorbance maximum between the wavelengths of from about 400 and about 650 nm.

16. The donor element as recited in claim 1, wherein said light-to-heat conversion layer is free of both carbon black and graphite.

17. The donor element as recited in claim 1, wherein said light-to-heat conversion layer is characterized by an absorbance maximum at a wavelength between 750 and 1200 nm that is larger than 0.2.

18. The donor element as recited in claim 1, wherein said light-to-heat conversion layer is characterized by a thickness in the range of from about 20 nm to about 300 nm.

19. The donor element as recited in claim 1, wherein said light absorber is selected from the group consisting of:
a) 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1];
b) 2-[2-[2-(2-pyrimidinothio)-3-[2-(1,3-dihydro-1,1-dimethyl-3-(4-sulfobutyl)-2H-benz[e]indol-2-ylidene)]ethylidene-1-cyclopenten-1-yl]ethenyl]-1,1 dimethyl-3-(4-sulfobutyl)-1H-benz[e]indolium, inner salt, sodium salt, having molecular formula C41H47N4Na1O6S3 and molecular weight of about 811 grams per mole;
c) indocyanine green, having CAS No. [3599-32-4];
d) 3H-indolium, 2-[2-[2-chloro-3-[(1,3-dihydro-1,3,3-trimethyl-2H-indol-2-ylidene)ethylidene]-1-cyclopenten-1-yl]ethenyl]1,3,3-trimethyl-, salt with trifluoromethanesulfonic acid (1:1) having CAS No. [128433-68-1]; and
e) combinations thereof.

20. The donor element as recited in claim 1, wherein:
said support layer and said light-to-heat conversion layer are free of any metallic layer and free of any metal oxide layer;
said light-to-heat conversion layer has a thickness in the range of from about 20 to about 300 nm, is free of carbon black and free of graphite, and has a local absorbance maximum larger than about 0.2 at a wavelength in the range of from about 750 nm to about 1200 nm;
said light absorber comprises a near-infrared dye;
said copolymer based on styrene and maleic anhydride is disposed in said light-to-heat conversion layer; and
said transfer layer comprises a pigment.

21. A method of making a donor element, comprising:
(a) providing a support layer;
(b) providing a light-to-heat conversion layer disposed adjacent one side of said support layer, wherein said light-to-heat conversion layer comprises a light absorber;
and
(c) providing a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer.

22. The method as recited in claim 21,
wherein said maleic anhydride-based polymer comprises a polymer selected from the group consisting of:
(i) maleic anhydride homopolymer;
(ii) maleic acid homopolymer;
(iii) fumaric acid homopolymer;
(iv) homopolymer of monoester of maleic acid;
(v) homopolymer of monoester of fumaric acid;
(vi) maleic anhydride copolymers;
(vii) maleic acid copolymers;
(viii) fumaric acid copolymers;
(ix) copolymers of monoester of maleic acid;
(x) copolymers of monoester of fumaric acid;
(xi) chemical combinations thereof;
(xii) physical mixtures thereof; and
(xiii) combinations thereof.;
wherein said maleic anhydride repeat unit is selected from at least one of the three configurations represented in 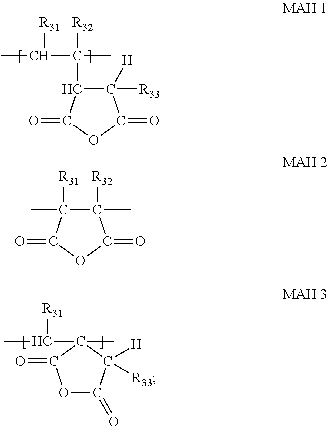
wherein said maleic acid repeat unit is selected from at least one of the three configurations represented in 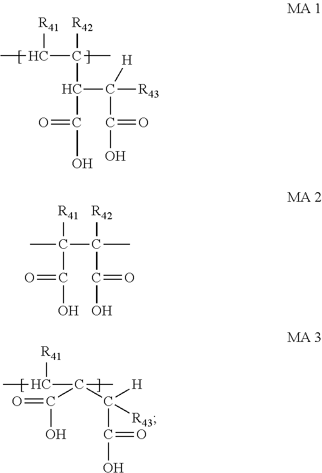
wherein said fumaric acid repeat unit is selected from at least one of the three configurations represented in 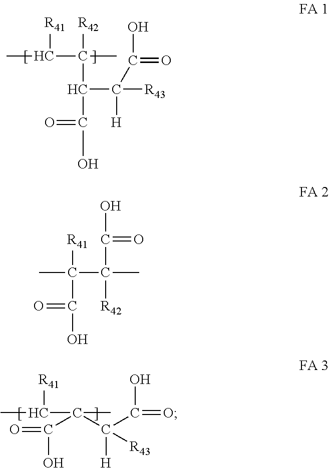
wherein said repeat unit of monoester of maleic acid is selected from at least one of the three configurations represented in 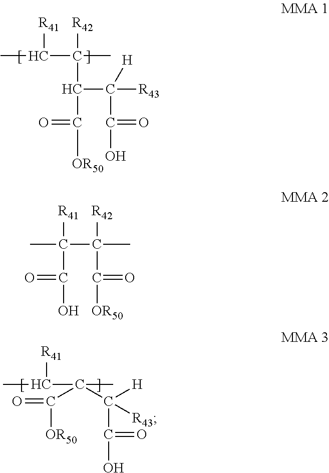
and wherein said repeat unit of monoester of fumaric acid is selected from at least one of the three configurations represented in 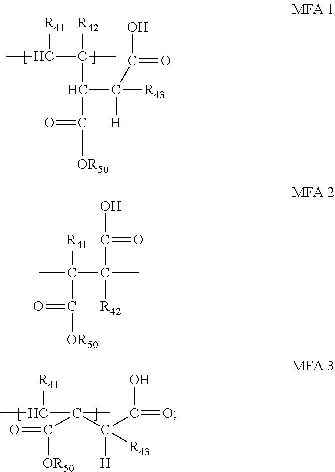
wherein, R₃₁, R₃₂, R₃₃ R₄₁, R₄₂, R₄₃ are the same or different groups, which can be hydrogen or alkyl of one to about five carbon atoms;
and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺; and
(g) combinations thereof.

23. The method as recited in claim 22, wherein said maleic anhydride-based polymer further comprises at least one type of repeat unit equivalent to that provided by the addition polymerization of at least one ethylenically unsaturated monomer.

24. The method as recited in claim 23, wherein said at least one ethylenically unsaturated monomer is selected from the group consisting of vinyl alkyl ethers, styrenes, vinyl acetate, ethylene, propylene, 1,3-butadiene, isobutylene, derivatives thereof and combinations thereof, wherein said alkyl said vinyl alkyl ether is from 1 to 10 carbon atoms.

25. The method as recited in claim 24, wherein said maleic anhydride-based polymer is a styrene-maleic anhydride polymer.

26. The method as recited in claim 25, wherein said maleic anhydride based polymer comprises a repeat unit equivalent to that provided by addition polymerization of monomers selected from the group consisting of an alkyl monoester of maleic acid, an alkyl monoester of fumaric acid, and combination thereof, wherein said alkyl monoester comprising 1 to 10 carbon atoms.

27. The method as recited in claim 26, wherein said maleic anhydride-based polymer further comprises a repeat unit equivalent to that provided by addition polymerization of maleic anhydride.

28. The method as recited in claim 27, wherein said maleic anhydride based polymer comprises the structure represented in Formula I: 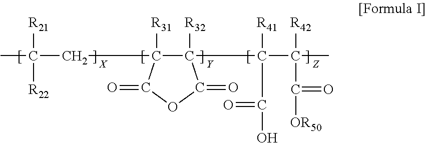
wherein x and z are any positive integer;
wherein y is zero or any positive integer;
R₂₁ and R₂₂ can be the same or different, and individually are hydrogen, alkyl, aryl, aralkyl, cycloalkyl, and halogen, provided that one of R₂₁ and R₂₂ is an aromatic group;
R₃₁, R₃₂, R₄₁ and R₄₂ are the same or different groups, which can be hydrogen or alkyl of one to about five carbon atoms; and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺; and
(g) combinations thereof.

29. The method as recited in claim 28, wherein R₂₁ and R₂₂, individually are hydrogen, methyl, phenyl, benzyl, or cycloalkyl of four to six carbon atoms.

30. The method as recited in claim 29, wherein R₂₁ R₃₁, R₃₂, R₃₃, R₄₁, R₄₂, R₄₃ are individually hydrogen, R₂₂ is phenyl, and R₅₀ is n-butoxyethylene (nCH₃—CH₂—CH₂—CH₂—O—CH₂—CH₂—).

31. The method as recited in claim 21, wherein said light absorber comprises a pigment.

32. The method as recited in claim 21, wherein said light absorber comprises at least one of carbon black and graphite.

33. The method as recited in claim 21, wherein said light absorber comprises a near-infrared dye.

34. The method as recited in claim 21, wherein said light absorber is characterized by having at least one local absorption maximum in the between the wavelengths of from about 750 nm and about 1200 nm.

35. The method as recited in claim 21, wherein said light-to-heat conversion layer is characterized by an absorbance maximum between the wavelengths of from about 650 and about 1200 nm that is at least three times larger in magnitude than said light-to-heat conversion layer absorbance maximum between the wavelengths of from about 400 and about 650 nm.

36. The method as recited in claim 21, wherein said light-to-heat conversion layer is free of both carbon black and graphite.

37. The method as recited in claim 21, wherein said light-to-heat conversion layer is characterized by an absorbance maximum at a wavelength between 750 and 1200 nm that is larger than 0.2.

38. The method as recited in claim 21, wherein said light-to-heat conversion layer is characterized by a thickness in the range of from about 20 nm to about 300 nm.

39. The method as recited in claim 21, wherein said light absorber is selected from the group consisting of:
a) 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1];
b) 2-[2-[2-(2-pyrimidinothio)-3-[2-(1,3-dihydro-1,1-dimethyl-3-(4-sulfobutyl)-2H-benz[e]indol-2-ylidene)]ethylidene-1-cyclopenten-1-yl]ethenyl]-1,1-dimethyl-3-(4-sulfobutyl)-1H-benz[e]indolium, inner salt, sodium salt, having molecular formula C41H47N4Na1O6S3 and molecular weight of about 811 grams per mole;
c) indocyanine green, having CAS No. [3599-32-4];
d) 3H-indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with trifluoromethanesulfonic acid (1:1) having CAS No. [128433-68-1]; and
e) combinations thereof.

40. The method as recited in claim 21, wherein:
said support layer and said light-to-heat conversion layer are free of any metallic layer and free of any metal oxide layer;
said light-to-heat conversion layer has a thickness in the range of from about 20 to about 300 nm, is free of carbon black and free of graphite, and has a local absorbance maximum larger than about 0.2 at a wavelength in the range of from about 750 nm to about 1200 nm;
said light absorber comprises a near-infrared dye;
said copolymer based on styrene and maleic anhydride is disposed in said light-to-heat conversion layer; and
said transfer layer comprises a pigment.

41. A method of using a donor element in a thermal transfer process to form an image, comprising:
(I) providing an assemblage of a donor element, said donor element comprising:
(a) a support layer;
(b) a light-to-heat conversion layer disposed adjacent one side of said support layer, wherein said light-to-heat conversion layer comprises a light absorber;
and
(c) a transfer layer disposed adjacent said light-to-heat conversion layer opposite said support layer, wherein said transfer layer comprises a material capable of being image-wise transferred from said donor element to an adjacent receiver element when said light-to-heat conversion layer is selectively exposed to light;
wherein the light-to-heat conversion layer comprises a maleic anhydride-based polymer;
(II) image-wise exposing said assemblage to light whereby at least a portion of said image-wise exposed transfer layer is transferred to said receiver element to form an image; and
(III) separating said donor element from said receiver element, thereby revealing said image on said receiver element.

42. The method as recited in claim 41,
wherein said maleic anhydride-based polymer comprises a polymer selected from the group consisting of:
(i) maleic anhydride homopolymer;
(ii) maleic acid homopolymer;
(iii) fumaric acid homopolymer;
(iv) homopolymer of monoester of maleic acid;
(v) homopolymer of monoester of fumaric acid;
(vi) maleic anhydride copolymers;
(vii) maleic acid copolymers;
(viii) fumaric acid copolymers;
(ix) copolymers of monoester of maleic acid;
(x) copolymers of monoester of fumaric acid;
(xi) chemical combinations thereof;
(xii) physical mixtures thereof; and
(xiii) combinations thereof.;
wherein said maleic anhydride repeat unit is selected from at least one of the three configurations represented in 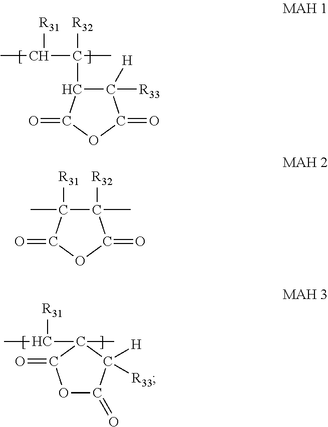
wherein said maleic acid repeat unit is selected from at least one of the three configurations represented in 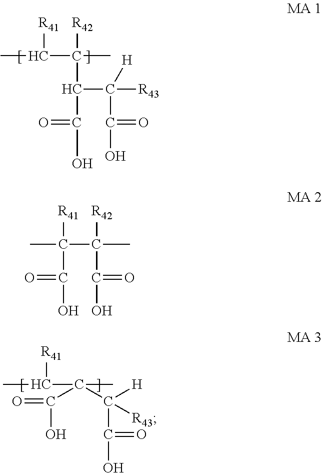
wherein said fumaric acid repeat unit is selected from at least one of the three configurations represented in 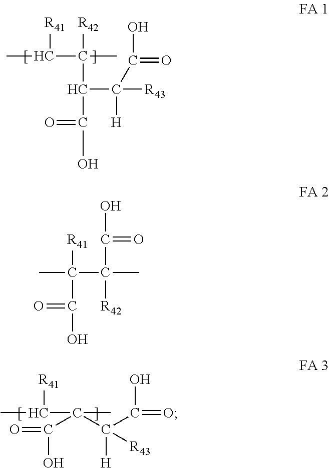
wherein said repeat unit of monoester of maleic acid is selected from at least one of the three configurations represented in 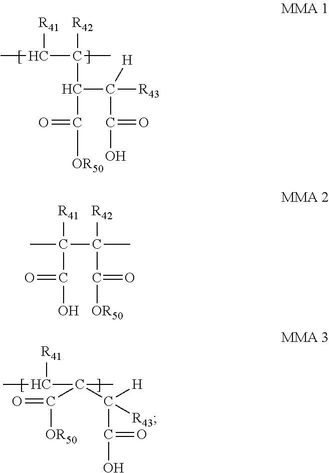
and wherein said repeat unit of monoester of fumaric acid is selected from at least one of the three configurations represented in 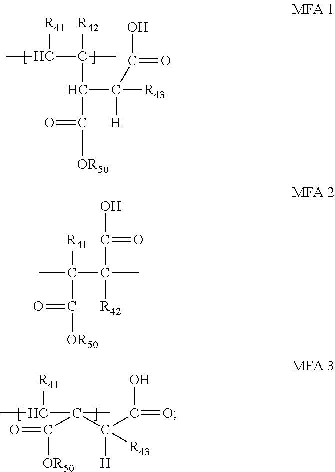
wherein, R₃₁, R₃₂, R₃₃, R₄₁, R₄₂, R₄₃ are the same or different groups, which can be hydrogen or alkyl of one to about five carbon atoms;
and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺, and
(g) combinations thereof.

43. The method as recited in claim 42, wherein said maleic anhydride-based polymer further comprises at least one type of repeat unit equivalent to that provided by the addition polymerization of at least one ethylenically unsaturated monomer.

44. The method as recited in claim 43, wherein said at least one ethylenically unsaturated monomer is selected from the group consisting of vinyl alkyl ethers, styrenes, vinyl acetate, ethylene, propylene, 1,3-butadiene, isobutylene, derivatives thereof and combinations thereof, wherein said alkyl said vinyl alkyl ether is from 1 to 10 carbon atoms.

45. The method as recited in claim 44, wherein said maleic anhydride-based polymer is a styrene-maleic anhydride polymer.

46. The method as recited in claim 45, wherein said maleic anhydride based polymer comprises a repeat unit equivalent to that provided by addition polymerization of monomers selected from the group consisting of an alkyl monoester of maleic acid, an alkyl monoester of fumaric acid, and combination thereof, wherein said alkyl monoester comprising 1 to 10 carbon atoms.

47. The method as recited in claim 46, wherein said maleic anhydride-based polymer further comprises a repeat unit equivalent to that provided by addition polymerization of maleic anhydride.

48. The method as recited in claim 47, wherein said maleic anhydride based polymer comprises the structure represented in Formula I: 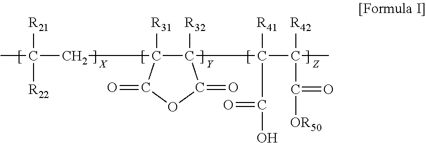
wherein x and z are any positive integer;
wherein y is zero or any positive integer;
R₂₁ and R₂₂ can be the same or different, and individually are hydrogen, alkyl, aryl, aralkyl, cycloalkyl, and halogen, provided that one of R₂₁ R₂₂ is an aromatic group;
R₃₁, R₃₂, R₃₃, R₄₁, R₄₂, R₄₃ are the same or different groups, which can be hydrogen or alkyl of one to about five carbon atoms;
and
R₅₀ is functional group selected from:
(a) alkyl, aralkyl, alkyl-substituted aralkyl radicals containing from one to about twenty carbon atoms;
(b) oxyalkylated derivatives of alkyl, aralkyl, alkyl-substituted aralkyl radicals containing from about two to about four carbon atoms in each oxyalkylene group, which can be of one to about twenty repeating units;
(c) oxyalkylated derivatives of alkyl, aralkyl, alkyl-substituted aralkyl radicals containing from about two to about four carbon atoms in each oxyalkylene group, which can be of one to about six repeating units;
(d) at least one unsaturated moiety;
(e) at least one heteroatom moiety;
(f) alkaline molecules capable of forming salts selected from Li, Na, K and NH₄⁺; and
(g) combinations thereof.

49. The method as recited in claim 48, wherein R₂₁ and R₂₂, individually are hydrogen, methyl, phenyl, benzyl, or cycloalkyl of four to six carbon atoms.

50. The method as recited in claim 49, wherein R₂₁ R₃₁, R₃₂, R₃₃, R₄₁, R₄₂, R₄₃ are individually hydrogen, R₂₂ is phenyl, and R₅₀ is n-butoxyethylene (nCH₃—CH₂—CH₂—CH₂—O—CH₂—CH₂—).

51. The method as recited in claim 41, wherein said light absorber comprises a pigment.

52. The method as recited in claim 41, wherein said light absorber comprises at least one of carbon black and graphite.

53. The method as recited in claim 41, wherein said light absorber comprises a near-infrared dye.

54. The method as recited in claim 41, wherein said light absorber is characterized by having at least one local absorption maximum in the between the wavelengths of from about 750 nm and about 1200 nm.

55. The method as recited in claim 41, wherein said light-to-heat conversion layer is characterized by an absorbance maximum between the wavelengths of from about 650 and about 1200 nm that is at least three times larger in magnitude than said light-to-heat conversion layer absorbance maximum between the wavelengths of from about 400 and about 650 nm.

56. The method as recited in claim 41, wherein said light-to-heat conversion layer is free of both carbon black and graphite.

57. The method as recited in claim 41, wherein said light-to-heat conversion layer is characterized by an absorbance maximum at a wavelength between 750 and 1200 nm that is larger than 0.2.

58. The method as recited in claim 41, wherein said light-to-heat conversion layer is characterized by a thickness in the range of from about 20 nm to about 300 nm.

59. The method as recited in claim 41, wherein said light absorber is selected from the group consisting of:
f) 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1];
g) 2-[2-[2-(2-pyrimidinothio)-3-[2-(1,3-dihydro-1,1-dimethyl-3-(4-sulfobutyl)-2H-benz[e]indol-2-ylidene)]ethylidene-1-cyclopenten-1-yl]ethenyl]-1,1dimethyl-3-(4-sulfobutyl)-1H-benz[e]indolium, inner salt, sodium salt, having molecular formula C41H47N4Na1O6S3 and molecular weight of about 811 grams per mole;
h) indocyanine green, having CAS No. [3599-32-4];
i) 3H-indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with trifluoromethanesulfonic acid (1:1) having CAS No. [128433-68-1]; and
j) combinations thereof.

60. The method as recited in claim 41, wherein:
said support layer and said light-to-heat conversion layer are free of any metallic layer and free of any metal oxide layer;
said light-to-heat conversion layer has a thickness in the range of from about 20 to about 300 nm, is free of carbon black and free of graphite, and has a local absorbance maximum larger than about 0.2 at a wavelength in the range of from about 750 nm to about 1200 nm;
said light absorber comprises a near-infrared dye;
said copolymer based on styrene and maleic anhydride is disposed in said light-to-heat conversion layer; and
said transfer layer comprises a pigment.

61. The method as recited in claim 41, wherein said light is provided by a laser having an energy output maximum at a wavelength between from about 650 nm and to about 1200 nm.

62. The method as recited in claim 41, wherein said light is provided by a laser having an energy output maximum at a wavelength between from about 650 nm and to about 800 nm.

63. The method as recited in claim 41, wherein said light is provided by a laser having an energy output maximum at a wavelength between from about 800 nm and to about 900 nm.

64. The method as recited in claim 41, wherein said light is provided by a laser having an energy output maximum at a wavelength between from about 900 nm and to about 1200 nm.

65. The method as recited in claim 41, wherein said transferred portion comprises an intact volume of said transfer layer.

66. The method as recited in claim 41, wherein said transferred portion comprises an intact volume of said transfer layer, said light is provided by a laser having an energy output maximum at a wavelength between from about 650 nm and to about 1200 nm and said transfer layer comprises a pigment.

67. The method as recited in claim 41, wherein said light is from about 40% to about 80% transmitted by said light-to-heat conversion layer during the imaging exposure.
